(19) United States
(12) Patent Application Publication
(10) Pub. No.: US 2009/0081629 A1
(43) Pub. Date: Mar. 26, 2009

(54) SYSTEM AND METHOD FOR MATCHING STUDENTS TO SCHOOLS

(76) Inventors: Chad Walter Billmyer, Santa Monica, CA (US); Stephen J. Clemente, Bridgewater, MA (US); Kenneth Utting, Neptune Beach, FL (US); Raymond Joseph Prisament, Ewing, NJ (US); Craig William Cornell, Carmel, IN (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 11/860,326

(22) Filed: Sep. 24, 2007

(51) Int. Cl. G09B 7/02; G09B 7/00; G05B 19/02

(52) U.S. Cl. 434/362; 434/322; 700/89

(57) ABSTRACT

A match algorithm is provided that matches, rather than filters, students and schools. The output of the algorithm informs the student as to how well he/she matches against every school in the database across many criteria. The student can sort and search through the rankings to identify the schools that are a best match; conversely, school administrators may sort and search through the student profiles to identify students that may be targeted for admission, may be more likely to matriculate to an enrolled student, persist through to the second year, graduate, and/or ultimately give back as an alum. Matches are based on profiles of the characteristics, interests, desires and level of interest and desire of the student matched against the characteristics profile of the college. The student may indicate how important many of these criteria are to him/her. The college information is s provided primarily by the colleges themselves via an annual survey. In addition, Affordability criteria may be generated that may be used as a Match Factor to find schools in the database that most closely fit the student's ability, willingness and desire to afford the school and minimize the debt burden to attend.

### FIELD OF THE INVENTION

The invention relates to a system and method for matching students with the schools that are the best fit for their characteristics, interests and desires using a match algorithm that comprehensively matches the students' desires and characteristics to available information about the schools. In particular, the invention relates to techniques and devices suitable for simplifying the selection of a school by an education seeking family and the selection of a student by a school.

### BACKGROUND OF THE INVENTION

For both a college-bound student and a college seeking student, optimized selection of the opposite member pair is obfuscated by asymmetric information. Additionally, both student and college profile data that might aid in optimized pairings often exists in systems that do not commingle the data. This is especially true on the side of the education seeking family. This asymmetric information leads to suboptimal pairings. Students end up at colleges that cost too much or too little where the student has a low likelihood of success. This leads a student to drop out or transfer. Statistics show that 60% of students change institutions at least once by the time they graduate. There is a cost to the education seeking family and there is a cost to the college when a student does not obtain a degree at a college at which he/she started. For example, when a student drops out of the education system after freshmen year, the average private school will loose $59,000 in tuition, fees, room, and alumni giving, while the average public institution will loose $14,000. It is desired to address this market inefficiency by better matching students to colleges.

Conventional techniques for matching students to colleges and universities include word of mouth, recommendations, college source books that provide information about the colleges and universities, and on-line systems that permit a student to filter data on the colleges to find those colleges that meet certain criteria. For example, the student may specify that he/she is looking for schools in New Jersey with fewer than 10,000 undergraduate students and a field hockey team. In response, conventional on-line systems provide a list of the schools that meet these criteria, but will provide no information at all on how well other schools might match the student on these or other criteria. Thus, conventional filter-based approaches to school research are only able to provide a list of the schools that match a student's criteria without any real attempt at matching the student to the college.

Numerous websites offer information to a college seeking student to assist in the college selection process. For example, Thatsmycollege.com creates an on-line community in which applicants, students, former students, high school counselors, and admissions officers may share information about colleges. Others sites, such as Zinch.com, enables students to post a detailed on-line portfolio about themselves for search by colleges and also provides college profiles that may be searched by the student. With Zinch.com, the students get to “tell their story;” however, no mechanism is provided for matching them by their characteristics to a particular college. Other sites, such as Cappex.com and Studentprospector.com, enable students to post on-line profiles that may be searched by colleges so that the colleges may choose to contact students of interest to the college. Similarly, Applyingtoschool.com enables students to submit a college application that is shared with colleges so that the colleges may contact students of interest to the college. However, none of these sites enable student profiles to be matched with college profiles based on academic, social, financial, and persistence (i.e., student's likelihood to persist and graduate) criteria. Moreover, none of these sites allow a student to determine the most affordable path to a college education by matching the student's financial needs to the financial aid packages potentially available to the student. Accordingly, conventional systems leave many unanswered questions for the student seeking a college or other school (graduate school, law school, trade school, etc.).

Also, each year, magazines such as U.S. News and World Report provide college rankings listing the rankings of the colleges in a number of different categories. However, no mechanism is provided for the student to determine the highest rated college for that particular student. For example, if Princeton is listed as the #1 national university, how is the student to know that Princeton is the #1 university for that student? A more personalized ranking system is desired that matches the student to the schools based on a number of academic, social, financial, persistence and other criteria. In particular, a ranking system is desired that computes a personalized college ranking list based on who the student is, where he/she wants to go, and how much he/she can afford to pay. The present invention has been designed to meet such needs in the art.

### SUMMARY OF THE INVENTION

The system and method of the invention addresses the needs in the art by implementing a match algorithm in connection with a website that together matches, rather than filters, students and colleges. For example, the system and method of the invention informs the student how well he/she matches against every school in the database across many criteria. The student can sort and search through the rankings by various means to identify the colleges that are a best match. In addition, matches in accordance with the invention are based on the characteristics, interests, desires and level of interest and desire of the student matched against the characteristics of the college. For this purpose, the student creates a profile of his/her characteristics, interests and desires. The student may indicate how important many of these criteria are to him/her. As a result, in addition to being able to indicate that he/she wants to go to a school in an urban setting in Massachusetts, for example, the student can indicate that he/she strongly wants to be in an urban setting, while he/she is only moderately interested in staying in Massachusetts. The student information is stored in a profile database and is provided primarily by the student; however, the student profile data also can be verified or supplemented by guidance counselors, parents, teachers, etc. On the other hand, the college information is stored in a college database and is provided primarily by the colleges themselves via an annual survey. The college data also can be gathered from other public and proprietary sources. In an exemplary embodiment, a quality rating can be associated with both the student and the college data points in order to reflect the reliability of the source of the information.

Each of the student characteristics, interests and desires are input into a Match Algorithm that computes a match referred to herein as a Match Factor. Preferably, the Match Algorithm provides both a rating and a quality score. For example, the rating may be a number of stars (e.g., one to five stars) indicating the degree to which the student's characteristics, interests and desires match with the college. On the other hand, the quality score indicates how much data is available to support the rating and the quality and importance of the data. For example, if one of the match factors is school cost, then a student's match with a school that provides cost information will have a higher quality than the student's match with a school that does not provide the cost information, or with a school whose cost information is two years old. Together, the rating and the quality are referred to herein as the Match Score.

In an exemplary embodiment, the Match Algorithm favors moderation. For example, suppose that the student is considering two colleges. One may offer a few things that are exactly what the student is looking for, but everything else is completely unsatisfactory. Another college may not be perfect in any regard, but comes reasonably close in most areas. Given a choice such as this, it is assumed by the Match Algorithm that most people would prefer the second college. In other words, it is assumed by the Match Algorithm that the students prefer moderation. For this reason, the Match Algorithm is designed to also prefer moderation. In an exemplary embodiment, the Match Algorithm is based on the Cobb-Douglas function (http:en.wikipedia.org/wiki/Cobb-Douglas) that was developed in the early twentieth century to represent the economic concepts of production and utility.

In an exemplary embodiment, the Match Algorithm also provides both an overall match and multiple sub-matches. For example, each of the Match Factors may be classified into one or more categories such as: Social, Academic, Financial, Persistence, Fit, and Feasibility. Categories can overlap. For example, the same Match Factor may be included in both the Social and Feasibility categories. As used herein, the Fit category refers to Match Factors that can be thought of as “I Want,” while the Feasibility category refers to Match Factors that are “I Am.” In other words, there are Match Factors that reflect student desires, such as the campus setting, number of undergraduates and intended major. These are “I Want,” or Fit, factors. The other Match Factors, like GPA or how much the student can afford to spend, are the “I Am,” or Feasibility Factors. Just as Match Factors are combined into an Overall Match Score, the Match Factors in each category can be combined using the identical algorithm to compute a match score for the category. The student can use such “sub-matches” to “drill-down” on the Overall Match Score to discover, for example, that a school is an excellent Academic match but a poor Social or Financial match, or to find out that there is a significantly higher quality behind the Academic portion of the Overall Match Score than behind the Social portion of the Overall Match Score. The student also may use sub-matches together with searching and sorting features in order to discover his/her top Fit or Feasibility matches, which may be very different from each other or from the Overall Match Score ranking.

The exemplary Match Algorithm also can be used to suggest Target, Reach and Safety schools. For example, the Match Algorithm analyzes the student and college data to suggest Target, Reach and Safety schools to the student, where Target schools are defined as those schools that are the strongest match between the student and school, based on all available information. This correlates to the Overall Match Score provided by the Match Algorithm, and the best Target schools have both a high Fit and high Feasibility score. On the other hand, Reach schools are commonly defined as schools that a student may not be highly qualified to be admitted to, or that are so selective that few students if any are assured admittance, but that a student would strongly like to attend. Reach schools have strong Fit but low Feasibility scores. Finally, Safety schools are schools that a student does not particularly want to attend in comparison to their target or reach schools, but ones in which the student is highly likely to be admitted to. Safety schools tend to have strong Feasibility but low Fit scores.

A system with these and other characteristics defined herein may be implemented on a web server including a Match Algorithm with access to the student data and college data described herein for use in conducting the matching. The web server so configured is accessible by a user via a web interface to the website. The user may be a student, or someone acting on the student's behalf, that is searching for a suitable college, or a college administrator, or someone acting on behalf of a college, to identify suitable students for that college. The above and other characteristic features of such a system will be apparent to those skilled in the art based on the following detailed description of the invention.

### BRIEF DESCRIPTION OF THE DRAWINGS

FIG. 1 illustrates exemplary Student data objects that store the student information.

FIG. 2 illustrates exemplary School data objects for storing the school information.

FIG. 3 illustrates exemplary Match Factor data objects for storing information related to matches for respective Match Factors.

FIG. 4 illustrates the overall structure of the Match Algorithm pipeline process in accordance with the invention.

FIG. 5 illustrates exemplary Match Factor algorithms implemented in accordance with the invention.

FIG. 6 illustrates on the left hand side a generic Factor Algorithm and on the right hand side an In-State/Out-of-State Algorithm as a specific example of a Factor Algorithm.

FIG. 7 illustrates another example of a Factor Algorithm, in this case the ACT Score Factor Algorithm.

FIG. 8 illustrates an exemplary embodiment of a Score Algorithm favoring moderation.

FIG. 9 illustrates an exemplary embodiment of a Rating Algorithm in accordance with the invention.

FIG. 10 illustrates an Overall Rating to the student for those schools determined to best match the student's profile.

FIG. 11 illustrates the ratings for Academic, Social and Financial Match Factors that make up an Overall Rating.

FIG. 12 illustrates a Saved Schools Manager that stores and manages match results for presentation and manipulation by the student.

FIG. 13 illustrates a student profile that a student may make available to admissions offices or other third parties through the use of a key.

FIG. 14 illustrates a sample graphical user interface through which a school administrator, for example, may specify the student characteristics sought by the school.

FIG. 15 illustrates the student's perspective of his/her communication history with different schools accessed using the matching system of the invention.

FIG. 16 illustrates a sample flow chart for calculating Affordability using the techniques of the invention.

FIG. 17 illustrates a profile manager for use by the student to generate a financial profile.

FIG. 18 illustrates a sample print out of the affordability assessment, or estimated award package, for a sample college for which such an Affordability calculation has been conducted in accordance with the invention.

FIG. 19 illustrates use of the estimated out-of-pocket costs as a Match Factor.

FIG. 20 illustrates a ranking of the Financial Match Factors for different schools.

FIG. 21 illustrates a user interface for enabling the student to provide financial information that may be used to assist a third party or a company associated with the web site operator to offer financial services that specifically target the student's needs.

FIG. 22 illustrates a login page for the user to login to the matching system of the invention.

FIG. 23 illustrates a welcome page presented to the student after login.

FIG. 24 illustrates a profile manager that guides the student through a series of questions used to generate the Student Profile.

FIGS. 25-40 illustrate graphic user interfaces including sample questions for use by the student in providing information for his/her Student Profile, where such information is used to generate Academic, Social, Financial, Persistence, and other Match Factors.

### DETAILED DESCRIPTION OF ILLUSTRATIVE EMBODIMENTS

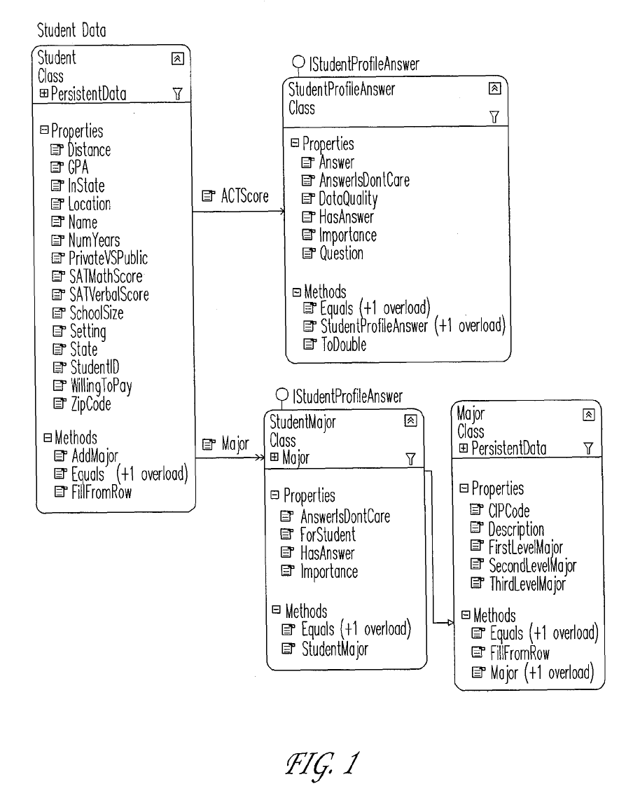

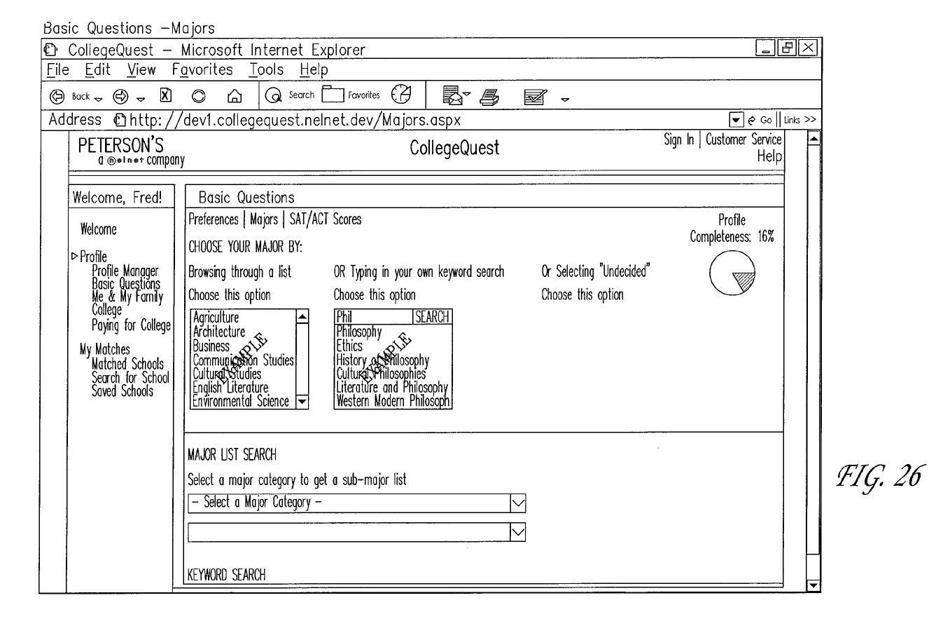

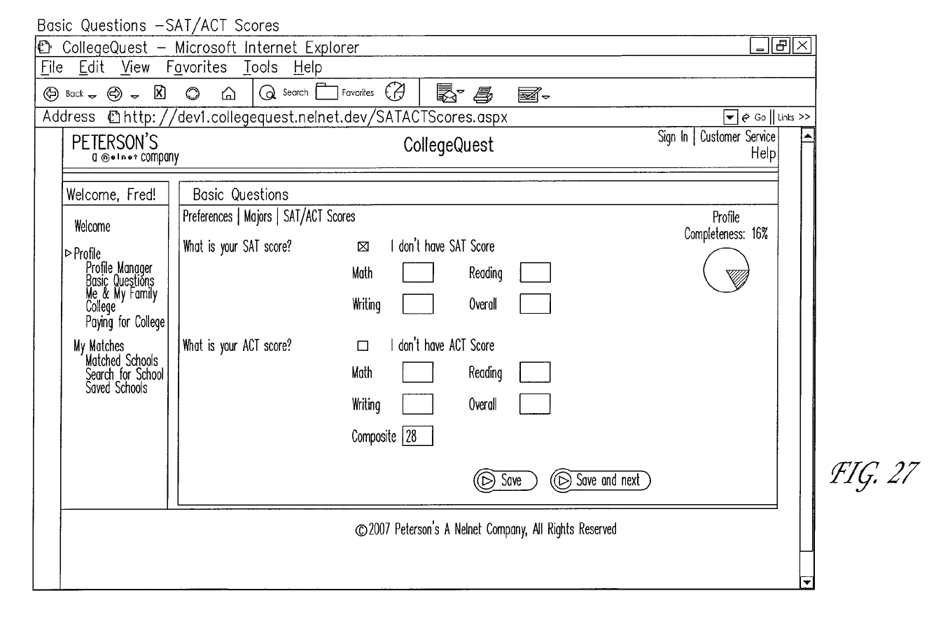

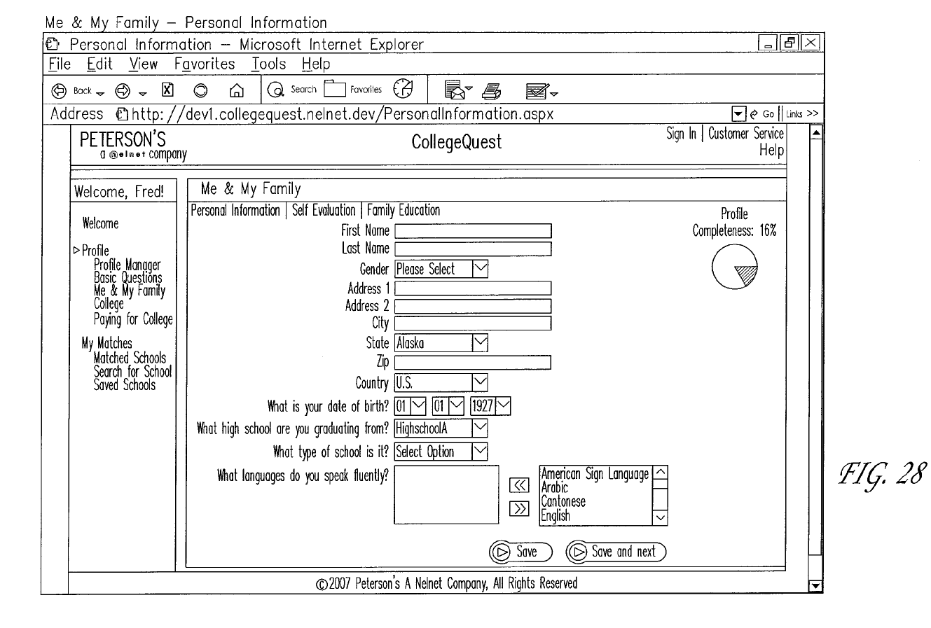

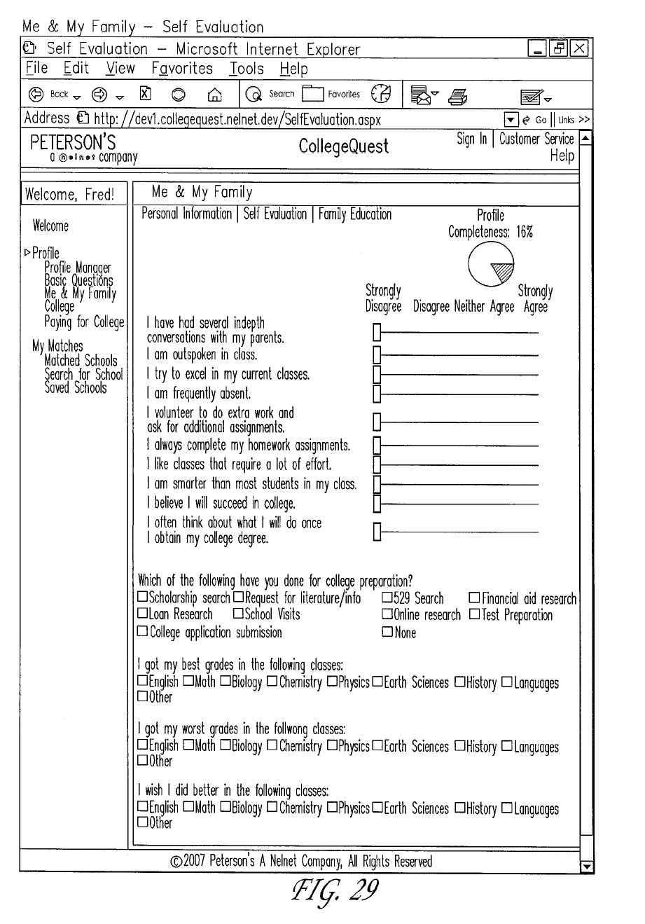

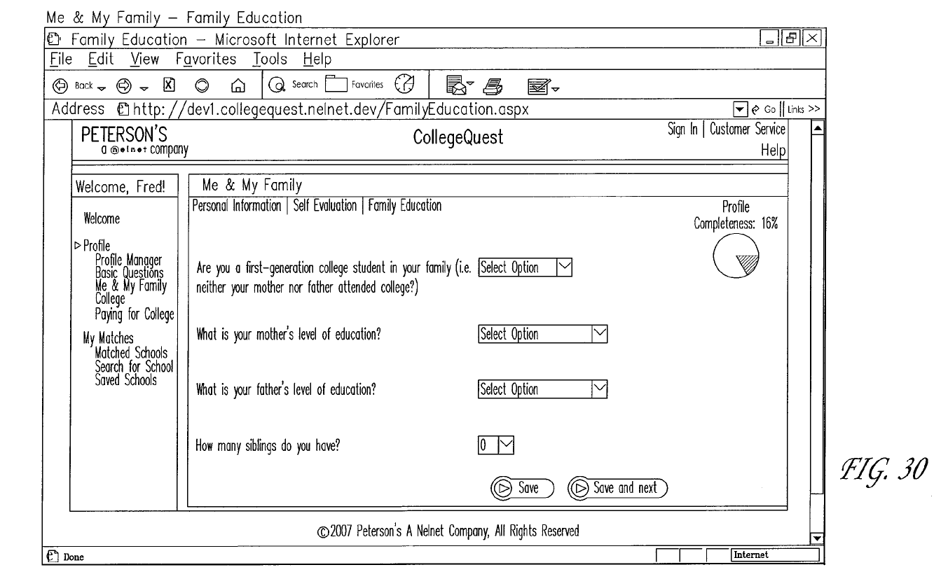

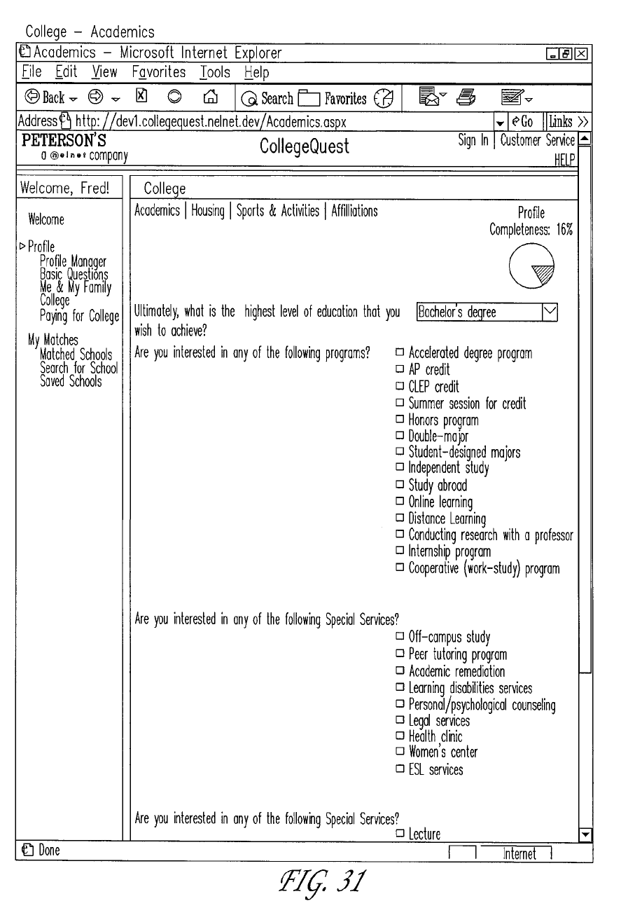

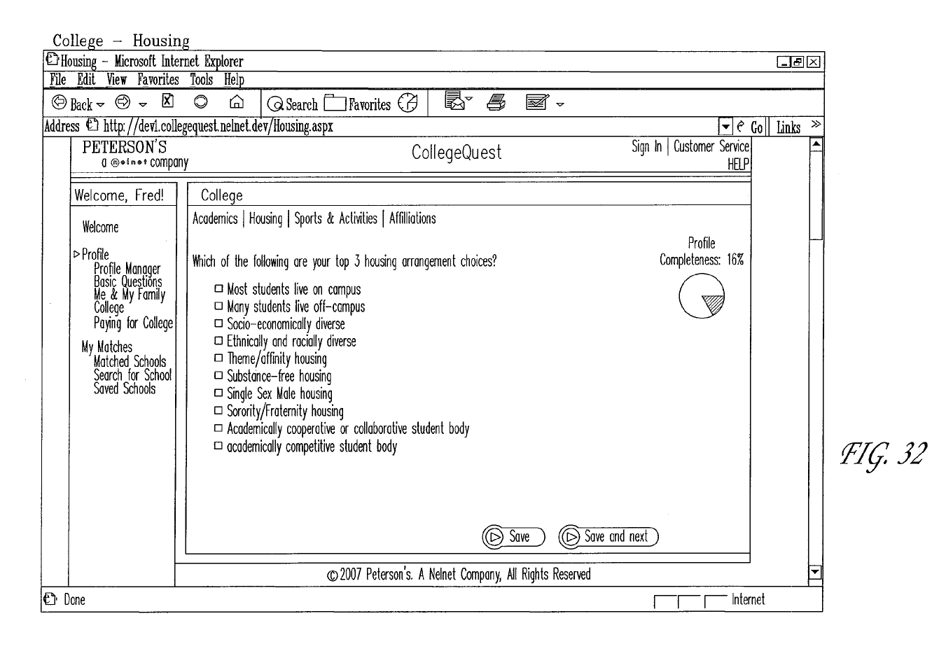

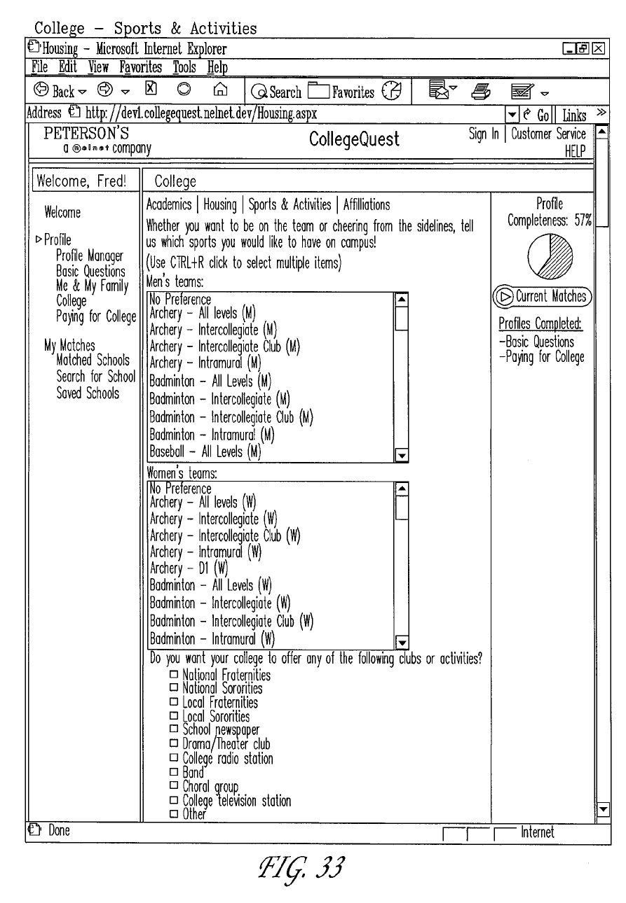

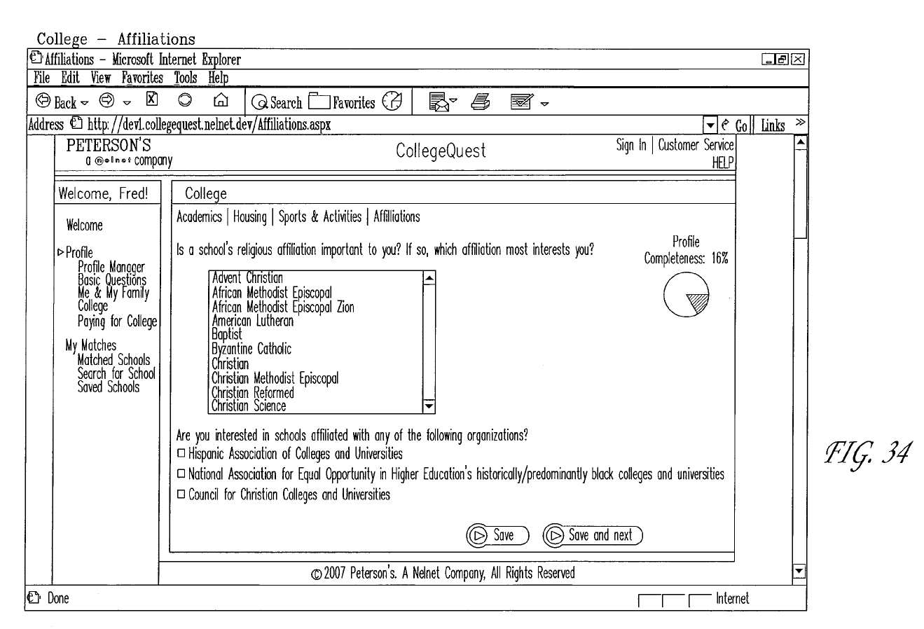

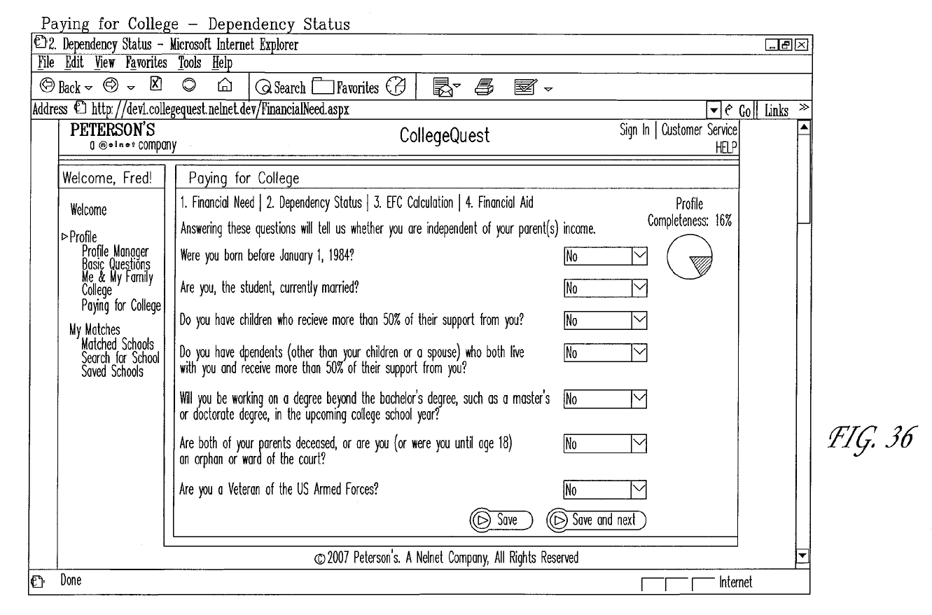

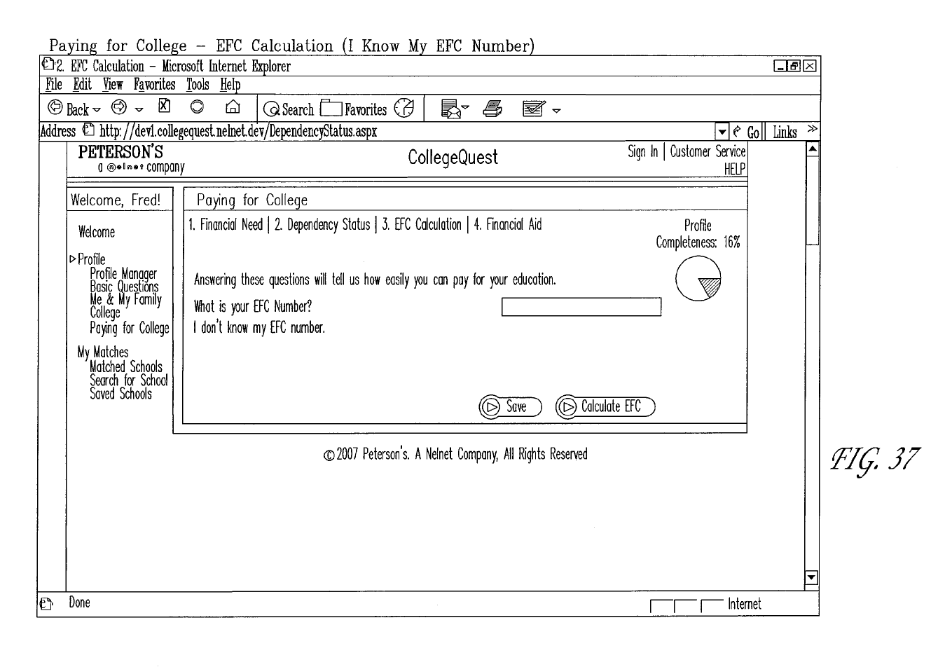

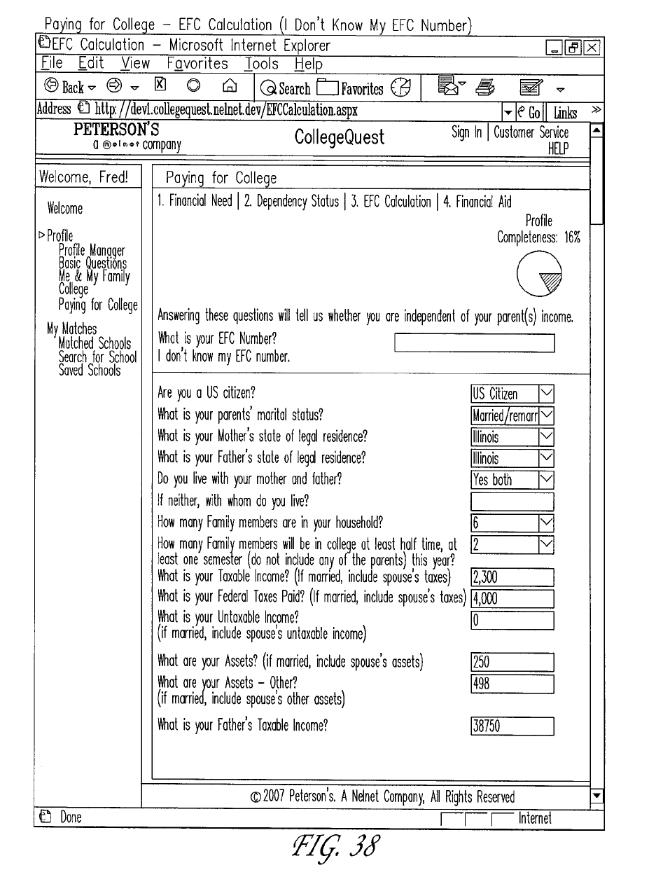

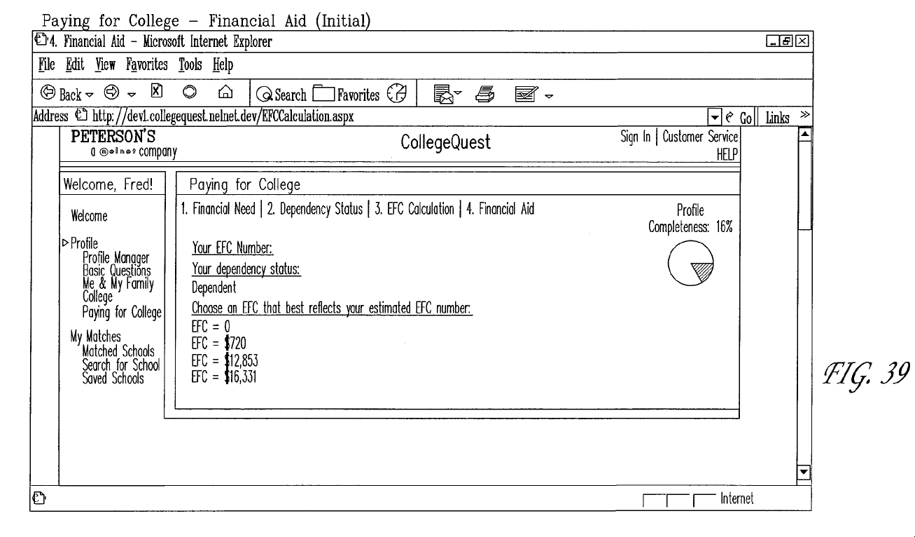

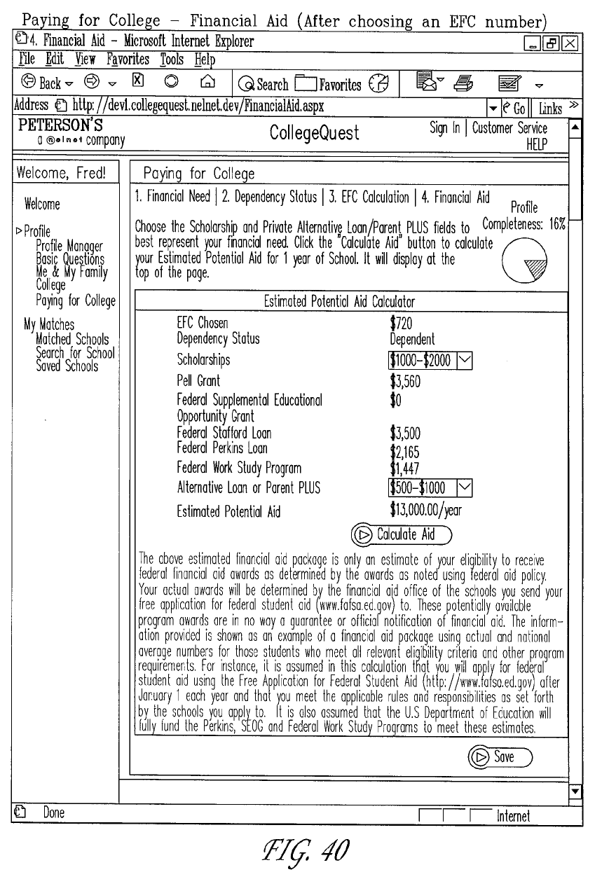

A detailed description of an exemplary embodiment of the present invention will now be described with reference to FIGS. 1-40. Although this description provides detailed examples of possible implementations of the present invention, it should be noted that these details are intended to be exemplary and in no way delimit the scope of the invention.

A. Student Data and School Data

The invention provides a Match Algorithm that compares information about a student with information about schools to generate a personalized school match list. The student and college information used by the Match Algorithm is stored in appropriate databases, such as SQL database with a SQL database server. Access to all databases is preferably provided by data service, rather than ADO.NET or a similar strategy. Of course, conventional web services may also be used for this purpose. In any case, the physical location of the student and college data is not particularly relevant to the invention. Wherever the data is stored, before running the Match Algorithm, the student data and college data is brought into memory and organized for processing by the Match Algorithm.

1. Student Data

Exemplary Student Data objects for storing the student information are illustrated in FIG. 1. As shown, the Student Data preferably includes the student Identity (User ID, Name, Address and so on) and the student profile. The student identity is managed by an Identity management service and by a registration database. On the other hand, the student profile may be stored as a set of tables indexed by the student's User ID. Each of the questions in the database has a column for the value indicated by the student (e.g. Setting=Urban). Interest and desire questions also have a column for the importance assigned to the question by the student on a scale such as 0-100. Some questions also have a data quality column, which also ranges on a scale, such as a scale from 0 to 1.0 that indicates the quality of the data. For example, the grade point average (GPA) answer may have a data quality column that is initially set to, say, 0.5 when the student enters the GPA information. However, when a guidance counselor verifies the GPA information, the data quality value may be increased to 1.0. This data quality value then may be used by the Match Algorithm to affect the Quality value of the associated Match Scores.

The student demographic and student profile data is collected by the Match Algorithm into a single primary Student class object. As illustrated in FIG. 1, the demographic data is stored as primitive types within the Student object itself. Most of the profile data, for example the ACT Score, is stored as StudentProfileAnswer objects, pointed to by the Student class object. The StudentProfileAnswer object not only stores the student's answer but also the importance assigned to the question, by either the student or the Match Algorithm, and the data quality indicator and other information. The student's choice of majors is stored as a list of StudentMajor objects, which is implemented as a subclass of Major. StudentProfileAnswer and StudentMajor share a common Interface so that they can be treated interchangeably by other code.

A common interface to the Student Data preferably defines three properties: HasAnswer, AnswerIsDontCare, and Importance. HasAnswer is a boolean value that indicates whether the student has (true) or has not (false) answered the corresponding profile question. AnswerIsDontCare is a boolean value that indicates whether the student has indicated that they Don't Care or have No Preference with respect to the corresponding profile question. Importance contains an integer in a range (e.g., 0 to 100) indicating the importance of the answer to the match, assigned either by the student or by the Match Algorithm.

The StudentProfileAnswer also adds three additional properties. Answer is a string containing a code for the answer selected by the student, and Data Quality is the data quality associated with the answer. This is either the value from the database, if available, or the default value of 1.0. Question is a string indicating the question for which this object is the answer. On the other hand, the StudentMajor class is a subclass of the Major class. In an exemplary embodiment, the Major class has five properties. CIPCode is a first, second or third-level CIP Code, stored as a string, representing a field of study selected by the student. Description is the text description of the major, such as “Animal Nutrition.” FirstLevelMajor, SecondLevelMajor and ThirdLevelMajor parse the CIPCode to return the appropriate first, second and third level majors, respectively. The StudentMajor class adds one more property, ForStudent, which is a pointer back to the Student object.

2. School Data

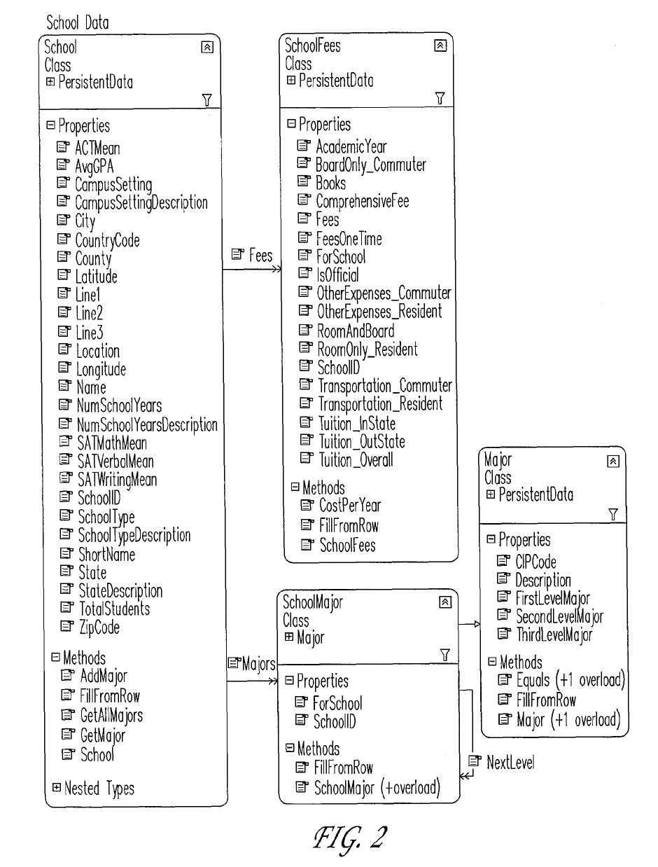

Exemplary School Data objects for storing the school information are illustrated in FIG. 2. School Data may be derived from annual surveys of all American colleges and universities. For example, Peterson's has developed an “undergraduate database” that includes the results of such annual surveys. The resulting School Data is stored in a series of tables that contain information on the school's characteristics, such as name, address, setting and size, on the majors offered by the school, and on the fees charged by, and other costs of attending, the school. School Data also may be derived from other public and proprietary sources. The resulting School Data can be used to determine the Match Score, but must never be displayed to the user. Therefore, the School Data is kept in a separate set of tables, even though it describes essentially the same range of information. Additionally, like the Student Data, the School Data associates a Quality score with each data column. Like the Student's Data Quality, the value ranges from 0 to 1.0 and indicates the degree of confidence placed in the School Data based on the source of the data, the age of the data, and how it was derived.

FIG. 2 illustrates the School data objects used to represent the collected School Data. School data objects contain data from sources that are not allowed to be displayed. Therefore, the School class is marked “internal,” which restricts access to the Match Algorithm code. As illustrated, the School class contains most of the collected School Data for the school. Information about school tuition, room and board and other fees is stored in a SchoolFees class, with a pointer from the School object to SchoolFees. The Match Algorithm allows the user to select any number of first, second or third level majors to indicate the fields the student is interested in studying. The Match Algorithm also allows “partial credit” for a school if it offers other majors within a first or second level major category selected by a student. That is, if the student selects major 01.0904, Animal Nutrition, then schools that offer majors in the first level category 01 or the second level category 01.09 could still receive a Match Factor score above zero, even if the school does not offer 01.0904 itself. In order to allow the Match Algorithm to quickly determine whether a school provides first, second or third level majors related to a particular major selected by a student, the Match Algorithm constructs a list of Major objects, where each object represents one of the first level majors offered by the school. Within each of these objects there is another list of Major objects, where each object represents one of the second level majors offered by the school. Similarly, within each one of these objects there is a third list of Major objects, where each object represents one of the third level majors offered by the school. Given any first, second or third level major CIP Code, the Match Algorithm can quickly traverse the list and determine how closely the school comes to offering that major.

3. Other Data

The Match Algorithm also may rely upon a zip code database that provides the latitude and longitude location of every zip code in the United States. This database may be used by the Match Algorithm to calculate the distance between a student and a school.

B. CIP Codes

Academic Majors are referenced by their CIP Code. CIP Codes provide a three-level hierarchy of majors. For example, one of the top level majors is 01., AGRICULTURE, AGRICULTURE OPERATIONS, AND RELATED SCIENCES. Under this major are fourteen second-level majors. One is 01.09, Animal Sciences. This particular second level major contains eight third-level majors, including 01.0904, Animal Nutrition. The CIP Codes are used to represent the Academic Majors offered by a college as well as the Academic Majors of interest to the student.

C. Match Factors

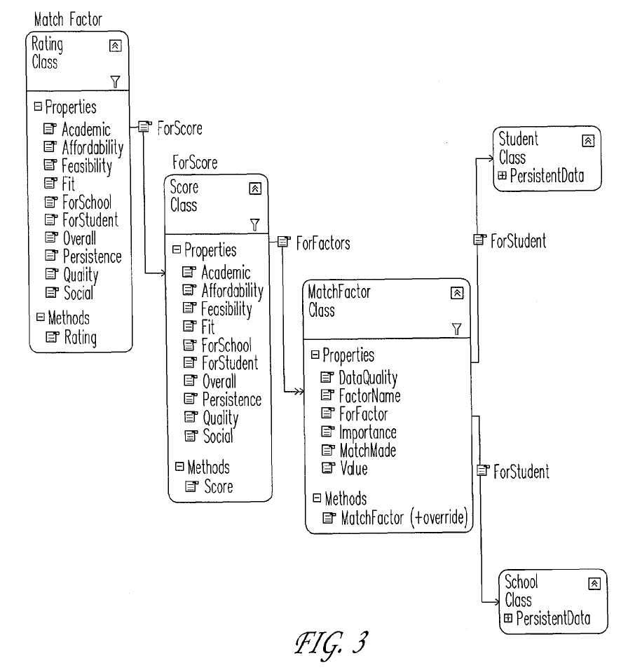

Each of the student characteristics, interests and desires used by the Match Algorithm to compute the match is called a Match Factor. Each Match Factor indicates how well a student and a college match on one aspect of the match, as well as the importance assigned to the factor (either by the student or by the Match Algorithm), and the quality of the data behind the match. As illustrated in FIG. 3, the MatchFactor object class includes FactorName, which is a string that indicates a name for the Factor, and is useful in debugging. ForFactor, on the other hand, is a pointer to the FactorAlgorithm object that computed the Match Factor.

1. Data Quality

The Match Factor DataQuality is one of a number of factors that the Match Algorithm considers when determining the Quality of a Match Score. DataQuality represents the quality of the data provided by the student and the school. The MatchFactor provides only this latter quality indicator. Others, such as the number of factors for which student and college data are available, are beyond the ability of the Match Factor to provide, and are considered further along the Match Algorithm pipeline (described below), where the scoring algorithm aggregates the quality of the data. In an exemplary embodiment, DataQuality is specified on a scale of 0 to 1, where 0 means that the data is as unreliable as if it were produced by a random number generator and 1 means that the data is certifiable fact. The Data Quality is computed by multiplying the quality of the student data times the quality of the school data.

2. Importance

The Match Algorithm weights the Match Factors differently, depending on how important each one is to determining how well a student and school match each other. For most Match Factors, the student may specify how important each factor is, as provided by the StudentProfileAnswer. Only the student can know, for example, whether that student considers the campus setting to be more important than the school size or vice versa. For these factors, if a student has not answered a question, or if the student has answered Don't Care or No Preference, then the Importance of the factor is set to 50. For other factors, the Match Algorithm must specify the Importance. For example, it does not really matter how important a student considers their GPA to be; it depends on the college as to how important GPA is when they consider who to admit into their freshman class. For these factors, the Importance is set by the Match Algorithm regardless of whether the student and school have provided the relevant data or not.

3. Match Made

A Match Factor may or may not be usable by the Match Algorithm to compute the match between the student and school. The student may not have answered the relevant question or questions in his/her profile, or the necessary data from the school may not be available. More precisely, a match is made if the relevant data is available from the student and the school, or if the student or school has indicated that they “don't care” or have no preference. In the latter case, a fixed value is assigned to the Match Factor, regardless of whether the relevant data is available or not.

4. Value

Value is an integer in the range 1 to 100. The FactorAlgorithm can compute a Value for the match in any conceivable way, from trivially simple to extremely complex as long as there is a reasonable argument to be made that the value accurately reflects how well suited the college and the student are for each other based on this one characteristic.

D. Match Score

Match Factors indicate the goodness of the match between a student and a school on one aspect of the match. The Match Factors are combined by the Score Algorithm into a single Match Score that indicates the goodness of the match between the student and school on all factors. Additionally, the Score Algorithm categorizes the Match Factors into multiple, possibly overlapping categories, and computes a Match Score for each category. The Score Algorithm preferably meets the goal of preferring “moderation,” that is, a match where many factors are good is preferred to one where a few factors are excellent and the rest are poor. There are many possible approaches to calculating a Match Score from the Match Factors. For example, the Match Algorithm may simply add up all the factor values and divide by the number of factors. However, this approach would not favor moderation. Accordingly, it is presently preferred that the Match Algorithm uses the Cobb-Douglas Algorithm, which is a model of production and utility used in modern economics. Other algorithms may also be used. For example, an algorithm may be used that does a good job of predicting persistence of students at college.

The general form of the Cobb-Douglas Algorithm is:

$$u = {\prod }_{i = 1}^{N} {x}_{i}^{ai}$$

That is, utility is equal to a collection of values raised to a power and then multiplied with each other. In addition, the powers ai should add up to 1 to produce an effect called “constant returns to scale.” That is, if one doubles all the inputs (xᵢ) the output (u) is doubled. As used by the Match Algorithm, the input values xᵢ represent each Match Factor's Value. The exponents aᵢ, which is the “weight” assigned to each Match Factor, represents each match factor's Importance. More precisely, the exponent is the Match Factor's importance divided by the total Importance of all made Match Factors.

E. Match Quality

In addition to computing the overall and categorized Match Scores, which indicates how well the student and the school match, the Score Algorithm also computes a Match Quality. This value indicates how much information has been compared, and what the quality of that information is. If a student and a school have been compared on many data points, the student and the school can have much more confidence in the Match Score than if they have been compared on just a handful of data points. Further, some of that data may have a lower quality than other data. For example, information about the cost of attending the school may be a year or two old, and may have had an inflation factor applied, whereas other data may be more current. Match Quality, then, is a measure of how much data has been compared between the student and a school and is, in a sense, a measure of the validity of the Match Rating.

1. Match Made

Match Quality could be computed by dividing the number of Made Factors by the total number of Match Factors. However, this approach does not take into account the relative Importance assigned to Match Factors by the user. For example, if the user adjusts the response for the campus setting question to a low value, then it should matter less if the Match Algorithm does not know a school's campus setting. It is also desirable to take into account the quality of the data, consistency of data, and whether the user had selected Don't Care or a similar selection as their answer. Match Made is just one factor in the Quality computation.

2. Importance and Data Quality

If data is missing, or low quality data is being used for a Match Factor that the student considers to be highly important, then the Match Quality is lower than if that factor were less important. However, if the student or school has indicated that they have no preference regarding a Match Factor, then the Match Algorithm knows less about what the student or school are looking for than if they made a more active choice. Therefore, the quality of the match is lower. The Match Algorithm handles this situation by assigning a value of 50 to the Importance of matches where No Preference has been specified.

3. Match Quality Algorithm

To compute a value for Match Quality, four quantities are computed:
MadeImportance This is the sum of the Importance for all Match Factors where a match was made.
TotalImportance This is the sum of the Importance assigned for all Match Factors.
MadeDataQuality This is the sum of the Data Quality for all Match Factors where a match was made.
MadeMatches This is the number of all Match Factors where a match was made.
   The Match Quality between a student and a school equals:

(MadeImportance/TotalImportance)*(MadeDataQuality/MadeMatches)

F. Match Rating

Like the Match Score, the Match Rating indicates the goodness of the match between the student and school on all factors. The difference is that whereas the Match Score represents the goodness of the match as an integer from 1 to 100, the Rating is a value of one, two, three, four or five stars. Also, like the Match Score, the Match Rating categorizes the Match Factors into multiple, possibly overlapping categories, and computes a rating for each category. Again, the difference is that one to five stars is assigned rather than a value of 1 to 100. The use of stars is preferred to the raw score because it groups the schools into more meaningful equivalence classes, blurs what may be non-meaningful distinctions between schools, and allows the student to more easily locate schools of interest. The Quality attribute of the rating may be copied directly from the Match Score.

G. Match Algorithm Pipeline

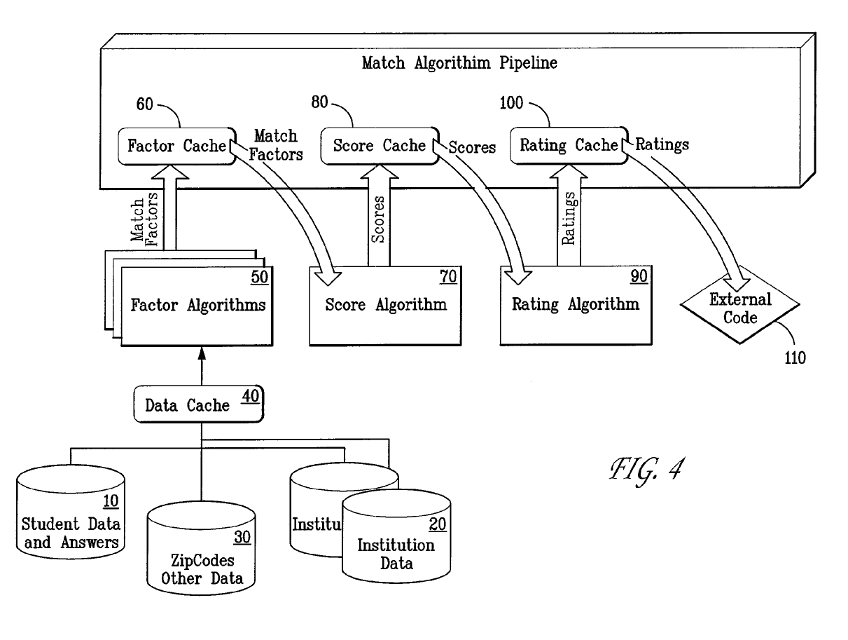

FIG. 4 illustrates the overall structure of the Match Algorithm pipeline process in accordance with the invention. The illustrated Match Algorithm pipeline may be implemented on a web server, server farm, and/or array processor accessible over the Internet or an intranet by a method call or web service by college and student users via a web browser, for example.

As discussed in detail above and illustrated in FIGS. 1 and 2, data processed in the Match Algorithm pipeline comes from two primary sources: student profile data, containing student demographic information and answers to questions, in a student database 10, and institution data, containing information about schools, in an institution database 20. Additional information, such as the latitude and longitude of all US Zip Codes, is also pulled from a zip code database 30. These databases can be quite large, and repeatedly pulling the same data can be very time consuming. Accordingly, much of the data may be cached in data cache 40 using data structures described above. Each Match Factor has a corresponding Factor Algorithm 50, embodied as a class. Each Factor Algorithm uses the data for a student and a school to compute a Match Factor, which is placed in the Factor Cache 60.

All the Match Factors for a student and a school are pulled from the Factor Cache 60 by the Score Algorithm 70, which uses them to compute the Match Score and Match Quality as described above. These scores are placed in the Score Cache 80. All the scores for a student or a school are pulled from the Score Cache 80 by the Rating Algorithm 90 to compute the Match Rating (number of stars). The Match Rating, together with the corresponding Match Quality, is passed into the Rating Cache 100, where it becomes available for use by external code 110, such as a web page for presentation to the user via a web interface.

The goals of the Match Algorithm pipeline architecture illustrated in FIG. 4 are to promote hardware and software flexibility and performance. The Match Algorithm is flexible because new factors can be introduced without affecting any of the existing factors. Also, the Score Algorithm 70 and Rating Algorithm 90 can be modified or replaced entirely without affecting any other portion of the Match Algorithm pipeline. As more is learned about college retention and other issues, changes like this will likely be required. The performance is enhanced by caching data, with the requirement that the caching be invisible to external code. That is, external code does not need to inform the pipeline when cached data becomes invalid.

H. Match Factor Algorithms

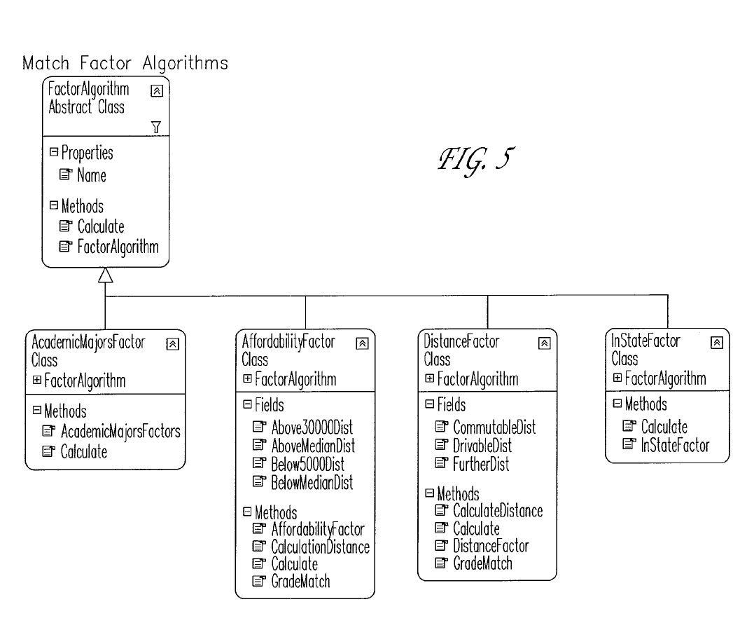

FIG. 5 illustrates exemplary Match Factor algorithms implemented in accordance with the invention. Each Match Factor provided by the Match Algorithm is calculated by a subclass of the FactorAlgorithm class. For example, there is an AcademicMajorsFactor, an AfordabilityFactor and a DistanceFactor. These algorithms calculate the Match Factor for the field the student intends to major in, how much the student is willing to pay for college, and how far from home the student would like to go to college.

Each Match Factor Algorithm follows the same general outline, but is unique in how it implements it.

1. Generic Factor Algorithm

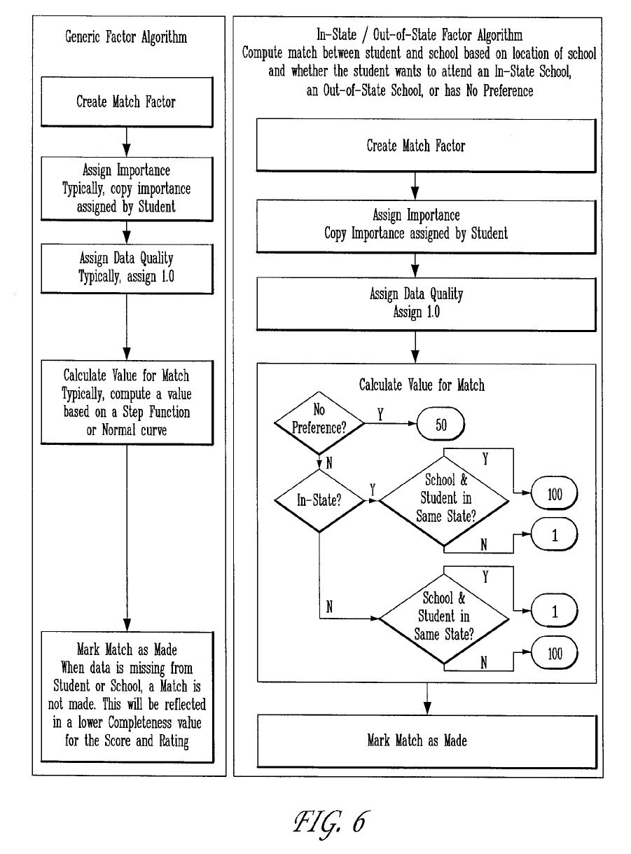

FIG. 6 illustrates on the left hand side a generic Factor Algorithm and on the right hand side an In-State/Out-of-State Algorithm as a specific example of a Factor Algorithm. In general, the generic Factor Algorithm of FIG. 6 begins by creating a new MatchFactor object. The MatchFactor represents the Value, Importance, DataQuality, and MatchMade attributes of the match between a student and a school on the factor. As noted above, a Factor Algorithm is provided for each factor to be matched. As shown in FIG. 6, after having created the MatchFactor, the Factor Algorithm assigns an Importance. As discussed above, every MatchFactor has a default Importance of 50, on a scale of 0 to 100. The Importance can be altered by the student, if the student sets a slider for the question in the graphical user interface and has not answered Don't Care or No preference, or by external code or the Match Algorithm itself for certain factors, such as Student GPA, where the student's view of the Importance is irrelevant. After assigning Importance, the Factor Algorithm assigns a Data Quality value. This value ranges from 0 to 1, and by default is 1.0. However, some factors compute a value for the Data Quality, which is the Data Quality of the student's data multiplied by the Data Quality of the school's data. The student data can be less than 1.0 when it can be verified, say by a Guidance Counselor, but has not been. The school data can be less than 1.0 when it has been derived from sources that are less reliable than, for example, the Peterson's Undergraduate Database. Next, the Factor Algorithm calculates the value, between 1 and 100, representing how well the student and school fit on this factor. The value can be calculated on a step function, on a normal curve, or in any way that makes sense. Some factors tend to have a range of answers that can be put into a sensible order.

For example, a Campus Setting Match Factor can be either Urban, Suburban, Small Town or Rural, and these can be arranged with Urban at one extreme and Rural at the other. Accordingly, a “distance” may be calculated between the student's choice and the college's characteristic. If the distance between extremes (Urban and Rural in this case) is defined to be 100, then the distance between Suburban and Small Town might be 33. Having calculated a distance, the distance itself might be the score for the Match Factor. Or, as in the case of Affordability, the distance might be applied to a curve. With the Affordability factor, the Factor Algorithm may calculate the difference between the amount the student is willing to pay and the amount the school costs, and call this the distance. It may then be assumed that a student may be somewhat willing to go to a school that costs more than that, but that the willingness will decrease as the cost of the school increases. It is also assumed that this willingness decreases according to a Normal distribution that is highest at zero and has a standard deviation of, for example, $3000 (the “willing to pay” options provided to the student increase in $5000 increments).

It may also be assumed that the student may be willing to go to a school that costs less than what they are willing to pay, but that this willingness also decreases as the cost of the school decreases, although it decreases less rapidly than when the cost of the school increases. Specifically, in this situation, it may be assumed that the willingness decreases according to a normal distribution that is highest at zero and has a standard deviation of $5000. Finally, as shown in FIG. 6, assuming that all the relevant data was available and a value could be calculated, the MatchFactor is marked MatchMade. However, when data is missing from the Student Data or School Data, a match is not made, which is reflected in a lower completeness value for the score and the rating.

2. In-State/Out-of-State Factor Example

As an example Factor Algorithm, the In-State/Out-of-State Factor Algorithm of the right hand side of FIG. 6 determines the match between the student and school based on where the student would like to go to school and where the school is located. As illustrated in FIG. 6, the In-State/Out-of-State Factor Algorithm begins by creating a MatchFactor. If the student has answered the question, then the Importance assigned by the Student is assigned to the MatchFactor. If there is no data quality issue for this factor; the MatchFactor retains the default value of 1.0. The value for the match is derived following the flow chart in FIG. 6. In this example, the value will simply be 1, 50 or 100. If the student has expressed No Preference, then the Match Factor for the student against any school will have a value of 50. If the student wishes to attend school in-state, then the Match Factor gets a value of 100 for schools that are in the same state as the student, and 1 for schools that are in any other state. On the other hand, if the student wishes to attend school out-of-state, then the Match Factor gets a value of 1 for schools that are in the same state as the student, and 100 for schools that are in any other state. Finally, having calculated a value, the Match Made attribute is set to True.

3. ACT Score Factor Example

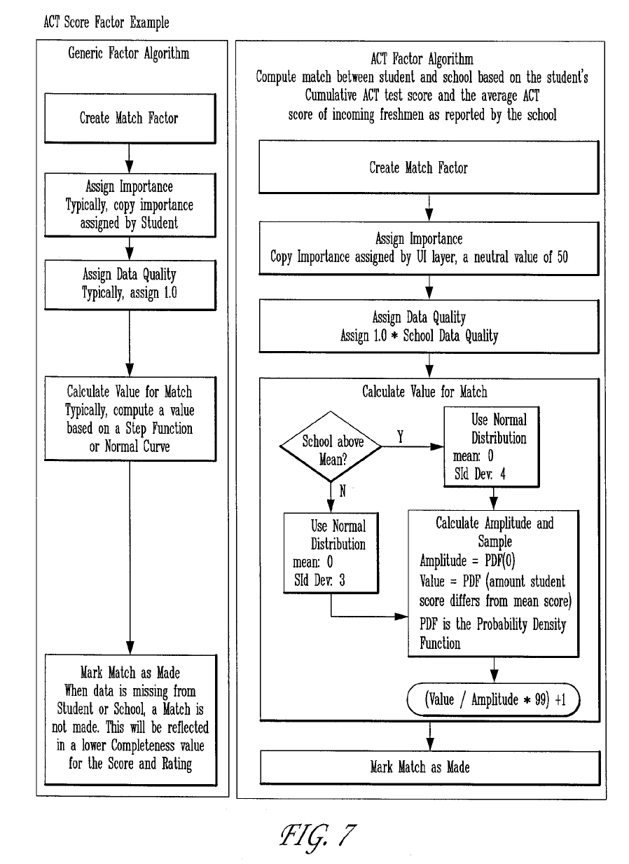

FIG. 7 illustrates another example of a Factor Algorithm, in this case the ACT Score Factor Algorithm. The ACT Score Factor Algorithm illustrated in FIG. 7 determines the match between the student and school based on the student's ACT Score and the school's Average ACT Score of incoming freshman. This Factor Algorithm begins by creating a MatchFactor. The importance of this question is not determined by the student but is instead determined by code external to the Match Algorithm pipeline since the relevance of the ACT Score is determined by the school. The value may be hardcoded, or more likely read from an external configuration file so that it can be changed as its effect on results is observed. Also, there is no data quality issue for the student data for this factor. Since there is no verification process, the data is assigned a quality of 1.0. On the school side, if the school reports their ACT information, it is assigned a Data Quality of 1.0. On the other hand, for various reasons many schools do not report an average ACT score for their incoming freshman. ACT Score may be derived, however, from various sources and assigned a Data Quality Value less than 1.0. Accordingly, the MatchFactor Data Quality value is assigned from the school's Data Quality Value.

The value for the Match is derived following the flow chart in FIG. 7. To calculate the value, the difference between the student's score and the school's value is determined. If the difference is greater than zero, then the student is above the school's mean. Otherwise, the student is below the school's mean. It is assumed that there is a greater likelihood that a student will fit well with a school where the other students have a lower ACT score than where they have a higher one, but that the fit is best where the student's score and the school's score are the same, and that the goodness of fit tails off in both directions according to a normal distribution. ACT scores range from 0 to 36. Accordingly, two normal distributions are pre-calculated where both have a maximum value, or Amplitude, at 0. One has a standard deviation of four, and the other has a standard deviation of three. The former distribution is used when the student is above the school's average ACT score, and the latter distribution when the student is below the school's average. The Probability Density Function of the curve is calculated at the difference between the student's score and the school's average score, and divided by the amplitude to get a value in the range of 0 to 1. This value is multiplied by 99 to get a value in the range of 0 to 99, and then 1 is added to get a final result in the range of 1 to 100. It should be noted that is important that the value of the match always be greater than zero since the Score Algorithm multiplies all the values together, whereby a value of zero for one factor would result in a value of zero for the entire Match Score. Finally, having calculated a value, the Match Made attribute is set to True.

I. Score Algorithm

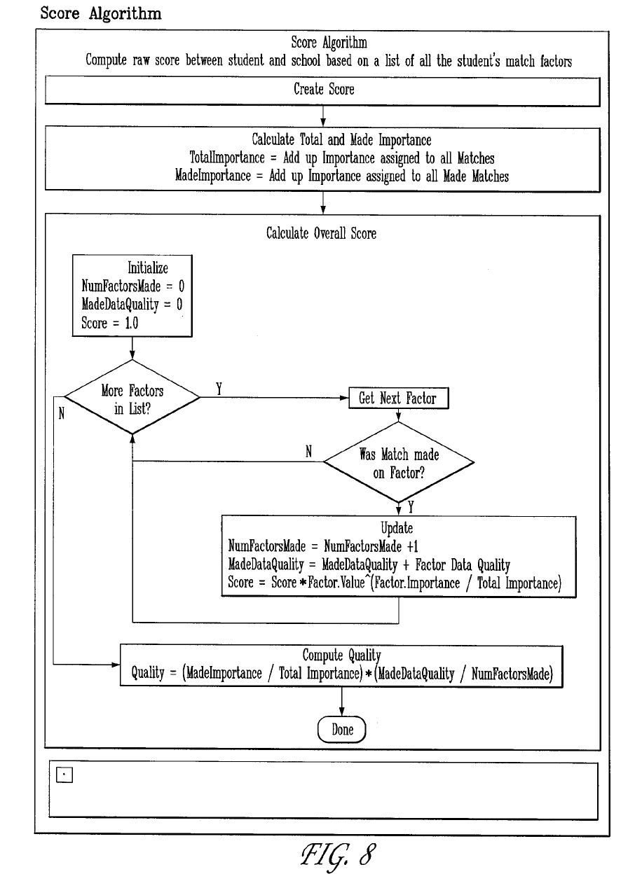

FIG. 8 illustrates an exemplary embodiment of a Score Algorithm favoring moderation. As noted above, the Score Algorithm is based on the Cobb-Douglas function, which tends to favor moderation, e.g., matches where a broad variety of factors have some degree of compatibility, rather than those where a few factors are very strong while the remaining ones are very weak. The quality aspect of the Score Algorithm informs the user of the relative amount and quality of data that was used to calculate the score. A score with higher Quality is probably more valid than a score with less, or less reliable, data. Generally, the Score Algorithm combines all the Match Factors for a student and a school into a single score and quality. It also computes Score and Quality values for each category (subset of Match Factors) identified by the Match Algorithm, such as Financial and Academic. The Score Algorithm is identical whether the Overall Score and Quality is being calculated or a Category Score and Quality is being calculated. The only difference is which Match Factors are combined; the Overall Score and Quality values are computed using all available Match Factors, whereas a Category Score and Quality is computed using just the Match Factors that belong to that category.

As illustrated in FIG. 8, in order to compute Score or Quality, the Score Algorithm first computes the Total Importance and the Made Importance. Made Importance is the sum of the Importance of all Made Match Factors, while Total Importance is the sum of the Importance of all Match Factors, regardless of whether the match was made or not. The Score Algorithm then initializes three values. NumFactorsMade is a count of how many Factors were Made, and is initialized to zero. MadeDataQuality is the total Data Quality of all Made Factors, and is initialized to zero. The Score is initialized to one. The Score Algorithm then loops over all Match Factors, selecting just the ones where the match was made. For each Made Factor, each of the three variables listed above are updated and NumFactorsMade is incremented by one. The Factor's Data Quality is added to MadeDataQuality. The Score is updated, according to the Cobb-Douglas Algorithm, by multiplying it by the Factor's Value raised to the factor's proportional share of the total Importance. At the end of this loop, the Score has been calculated. In order to calculate the Quality of the match, the Made Importance is divided by the Total Importance, and this is multiplied by the Made Quality divided by NumFactorsMade.

J. Rating Algorithm

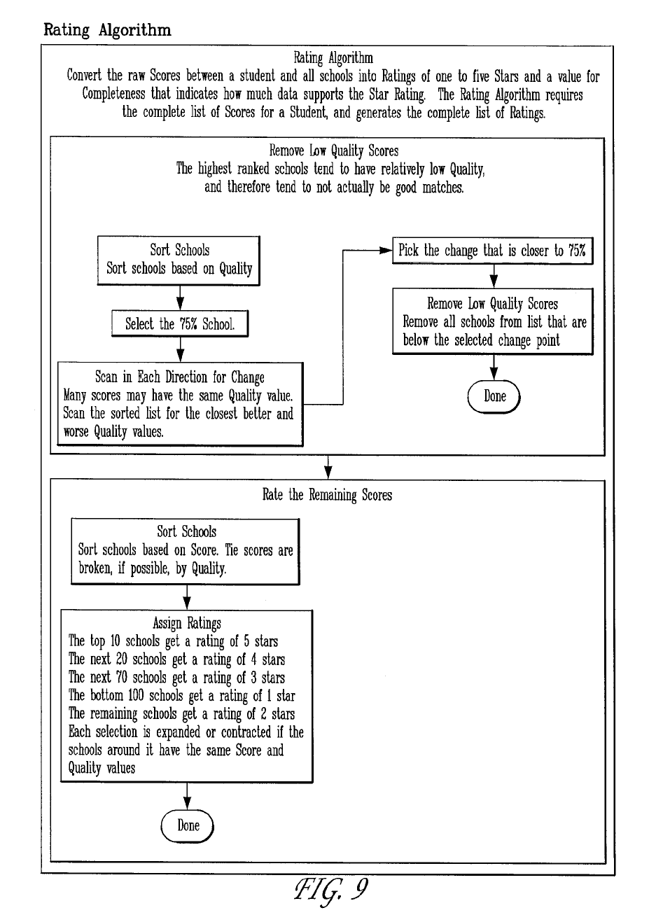

FIG. 9 illustrates an exemplary embodiment of a Rating Algorithm in accordance with the invention. The task of the Rating Algorithm is to convert the Match Scores into a simpler to understand one to five star rating. Five star schools are those that the student is most likely to be a good fit for. One star schools are those that the student is least likely to be a good fit for. There are many approaches that could be taken to perform this task, and some are at considerable odds with each other. The Match Algorithm is designed to allow one algorithm to be easily substituted for another, and this is very likely to occur over time. One important characteristic of the Rating Algorithm is whether it produces five star matches for every student. That is, does the rating tell the student “This is the best match for you” or “This is the best match possible.” The former approach is fairly simple; the Rating Algorithm can rank the student against all the schools, sort the result by Match Score, and the top matches are five star schools. The latter approach is more complex in that the Rating Algorithm would need to rank many students against schools and perform a statistical analysis of what the best scores are before the star ratings may be assigned. One benefit of the latter approach is that students and schools will see the same rating. However, one drawback is that many students will tend to have many schools with the identical rating, and so there may be little benefit to them for using the website. Another drawback is that one would need to have a significant number of student Profiles available before one could begin to provide Match Ratings.

Because of these drawbacks, in an exemplary embodiment, the first approach is taken for the Rating Algorithm. A student is matched against all the schools, and the Rating Algorithm then selects approximately the top ten as five star schools, the next twenty as four star schools, the next seventy as three star schools, the bottom one hundred as one star schools, and the remainder as two star schools. These cutoff points are only approximate, because it is desirable that all schools that have a tied Match Score and Match Quality have the same Match Rating. So for each cutoff point, the Match Score and Match Quality of the Match at that point is examined and then the list is scanned in each direction to find the points where the Match Score or Match Quality changes. Whichever of these two points is closer to the original cutoff point becomes the actual cutoff point.

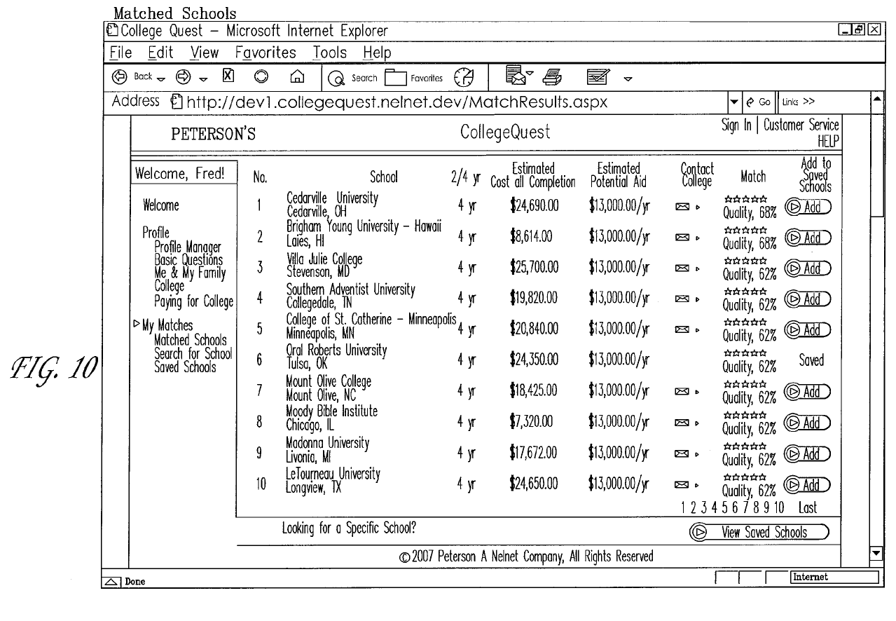

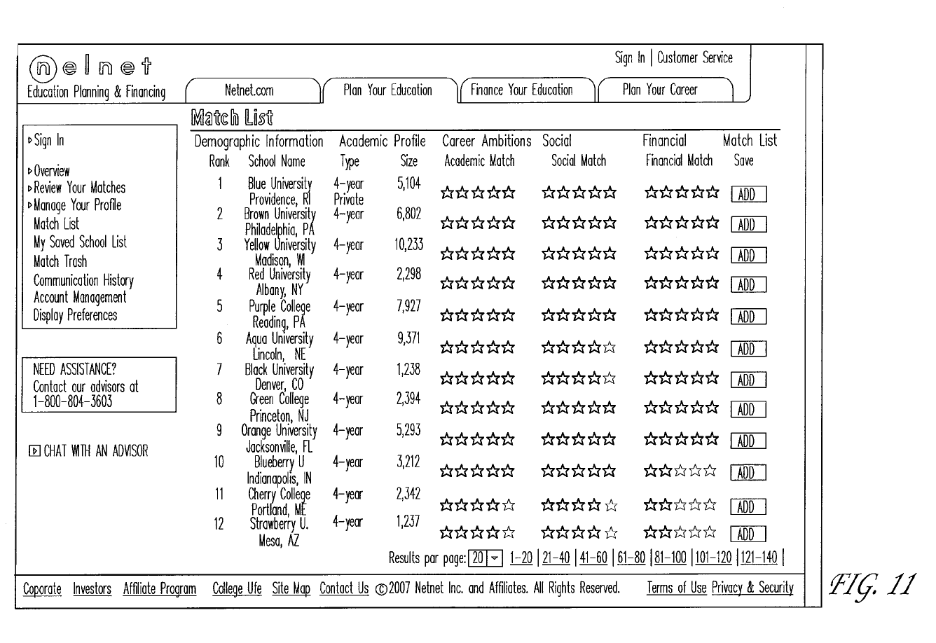

The Rating Algorithm may provide a match rating based on the Overall Score and/or a rating that is applied to each respective sub-score category, such as Academic and Social. For example, FIG. 10 illustrates an Overall Rating to the student for those schools determined to best match the student's profile, while FIG. 11 illustrates the ratings for Academic, Social and Financial Match Factors.

1. Dropped Matches

If a school and a student are matched on just a few factors, the odds are that a complete spectrum of results will be obtained, from extremely poor to extremely good. However, as the number of factors increases, the odds of an extremely good match decreases, because it becomes harder and harder for the student and school to match well on every single factor. Because of this, if the Match Ratings of a student against all schools is simply reported, the top Match Ratings will tend to be schools with fewer data points, i.e., they will have a lower Match Quality. In fact, many of the matches will essentially be invalid. Therefore, the Match Algorithm computes a Match Score and Match Quality for the student against all schools, then sorts the list. Approximately twenty-five percent of the matches at the bottom of the list are dropped. Again, the cutoff point is approximate because it will slide up or down, as described above, so that all matches with the same Match Score and Match Quality will either remain in the list or be dropped from it. Sorting of the ratings by Match Quality is illustrated in FIG. 10.

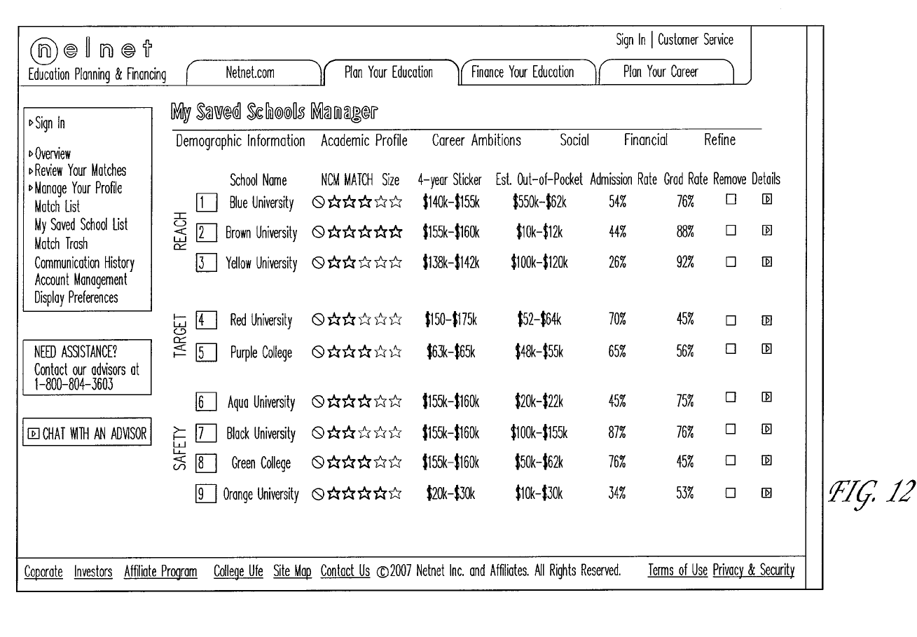

In an exemplary embodiment, the match results for a student may be saved by the student in a secure area of the student database 10 for which access is regulated using conventional password login techniques. The student's profile may also be stored in a secure area of the student database 10 for which access is limited. The stored match results may be managed by a Saved Schools Manager routine of the type illustrated in FIG. 12 for presentation and manipulation by the student.

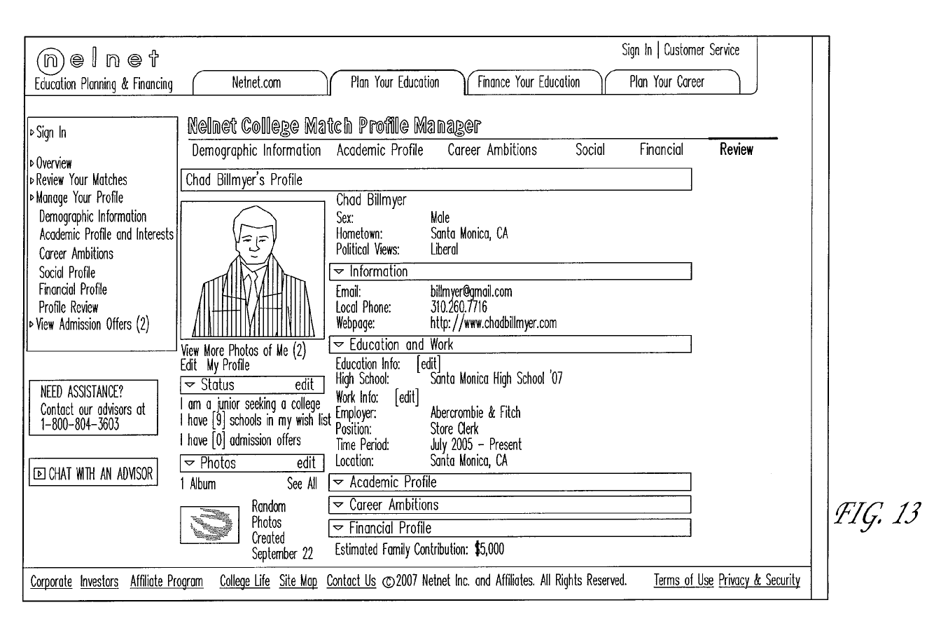

The system of the invention may also provide a way for a student to make a visually pleasing version of his/her Student Profile of the type illustrated in FIG. 13 available to admissions offices through the use of a key. In particular, through the selection of a check-box, a student can choose to make his profile available to a member of the general public. Upon selection of the option, the student has the option to add a password to the public profile. If the student makes his profile public and chooses a password, the profile will exist at a URL. In order for a member of the public to access the profile, the student must share the URL with the member of the public. The student must also share the password. When the member of the public goes to the URL, the member of the public will be prompted to submit the password that the student created for access to the profile. Thus, the student profile may be accessed by those parties to which the student grants access to the student's profile in student database 10. On the other hand, the stored information may be forwarded to third parties by the student using e-mail, for example.

2. School Perspective

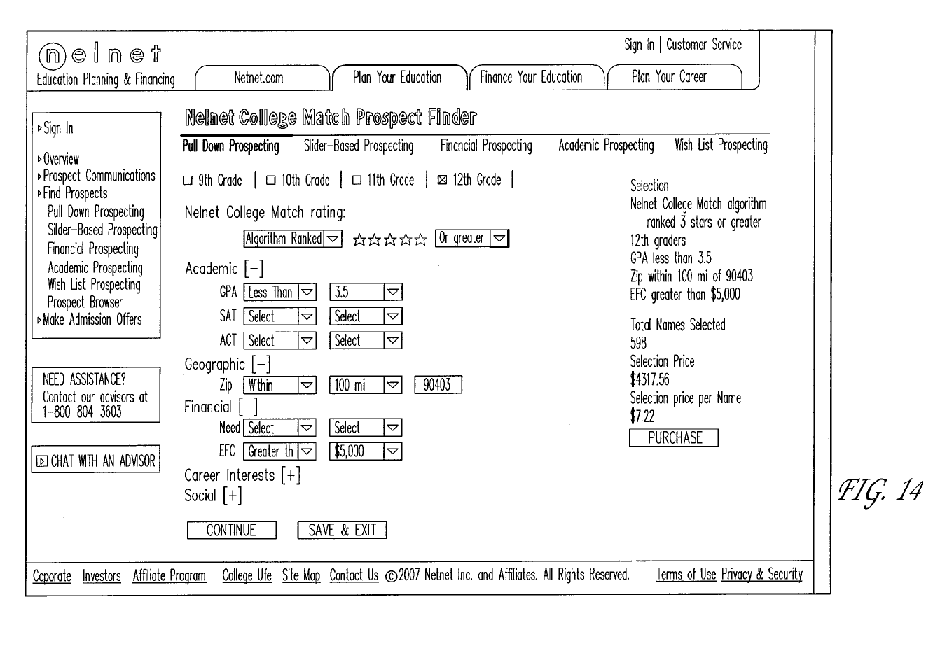

The description of the Match Algorithm pipeline and its interfaces has been described herein, for simplicity, principally from the perspective of a student looking for schools. However, the system also allows a school to look for students in an analogous manner, with important benefits to the school over traditional approaches in that the school may seek students with particular characteristics and then solicit the student. The Match Factor and score portions of the Match Algorithm Pipeline work exactly the same way, whether ranking students against schools or schools against students. The only difference in the Match Algorithm pipeline is that an application program interface (API) method for rating the school (Rate(School)) with respect to all or part of the students is called, instead of the API method for rating the student (Rate(Student)) with respect to all or part of the schools. Rate(School) creates a list of all the student profiles in the database and asks the Score Algorithm for the score of the school against all these students. The Rating Algorithm then drops the lowest quality matches, just as when rating a Student. FIG. 14 illustrates a sample graphical user interface through which a school administrator, for example, may specify the student characteristics sought by the school.

As noted above, various Rating Algorithms are possible and a particular Rating Algorithm may generate different ratings when rating a student than when rating a school. That is, even though the scores are identical, scores are converted to stars in a way that produces different stars for the same school/student pair, depending on whether the system is rating the student or the school. For example, School X may be the best school for Student Y, and therefore X is rated five stars for Y. However, there may be many students that are a better fit for X, and therefore Y is rated three stars for X. When rating students for a school, the Rating Algorithm assigns a five star rating to approximately the top ten percent of students in the list. Four stars are assigned to the next twenty percent. Three stars are assigned to the next twenty percent. Two stars are assigned to the next twenty five percent, and one star is assigned to the remaining twenty-five percent. Again, as above, the division points are slid either up or down to ensure that all matches with the same score are assigned the same rating.

It should also be noted that the API may also permit a student to match himself/herself with respect to a particular school (as opposed to the entire school database), and vice-versa. In addition, the system of the invention may further provide a number of on-line tools that enable students and schools to leverage the information in each other's profiles. For example, as just noted, the Match Algorithm may be used to determine how well particular student and school profiles match. Search tools may also be provided that allow students and colleges to match profiles to find, for example, colleges that offer water polo or students who play water polo. Communication tools may also be provided that allow students to request information from colleges on-line and for colleges to request information from students on-line. For example, the illustrated match results could also include email links to the respective schools found in the match. Similarly, assuming the student has approved the release of his/her information to the college, email links to students may also be provided to the colleges as a result of a student match run by a school administrator, for example.

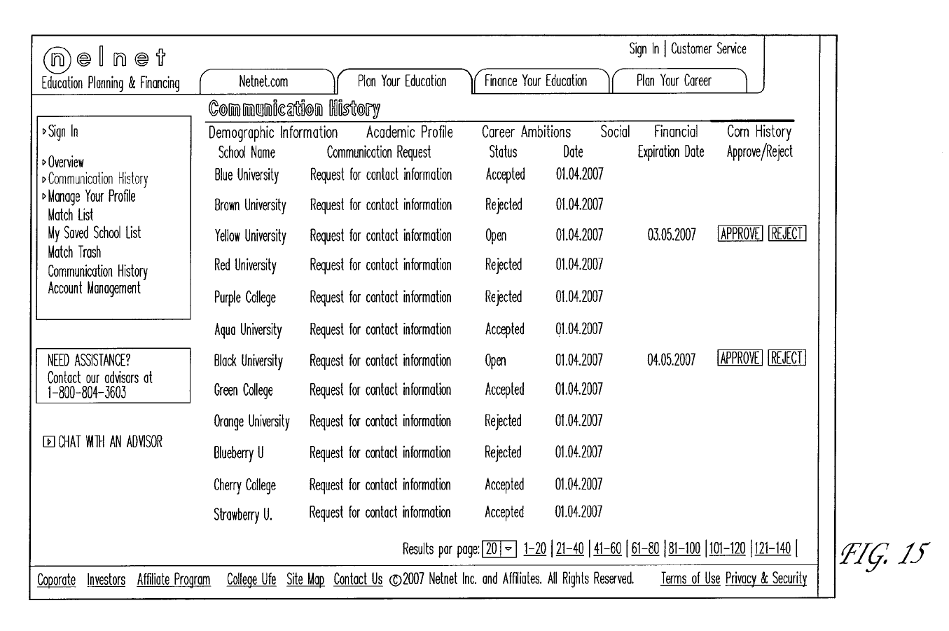

As another example, if a student is interested in learning about a particular school, the student can bring up a page that contains information about that school. If more information is needed, the student can click a link or button that sends a message to the school along with contact information (e.g., name, address, e-mail, phone) for the student. The school could then send brochures, pamphlets, and other promotional material directly to the interested student. On the other hand, if a college purchases a set of names based on a student search, the college can obtain a minimal set of information about the student as allowed under applicable privacy laws. The college may also send an email invitation to the student, inviting that student to contact the school as above to obtain more information. The college further decides if it has too little, too many, or just the right amount of identified matches. If there are too little or too many, the college may search for additional candidates or further refine the list using the student search techniques described above. On the other hand, if the college has the right amount of student matches, the college may agree to pay a predetermined amount per name. The system sends each student an invitation to release the student's information to the college. If the student approves the release of her information to the college, the college gets charged per name. However, if the student rejects the request, the college does not incur a charge. FIG. 15 illustrates the student's perspective of this process.

K. Matching Based on Affordability

As noted above, one of the Match Factors used to match students and schools is Financial. This Match Factor may be derived from a number of characteristics provided in the Student Data and the School Data. As will now be described, such a Match Factor further enables the system and method of the invention to incorporate into the Match Algorithm the concept of Affordability. In other words, Affordability may be a separate category of Match Factors used in the Match Algorithm to enable a student and the student's family to determine the relative match with a school taking into consideration the student's ability and willingness to afford that school. In particular, by matching the student to a school based on Affordability, the system of the invention allows the student to find a school that will ultimately maximize affordability and minimize debt for the student, while also optimizing the student's learning experience based on general compatibility with the school based on the profile match.

### Affordability Defined

The Affordability component of the Match Algorithm may be considered in iterative stages. These are defined below.

### Stage One

The first stage of affordability assessment encompasses using the US Department of Education's federal financial aid calculation (a.k.a., The Federal Methodology) to determine the student and family's financial strength. This is an annual process for aid seeking students and the online application is found at www.fafsa.ed.gov The result of the Federal Methodology is a number called the Expected Family Contribution (EFC). The EFC is a measure of the family's financial strength and is used by schools' financial aid offices to award student aid according to federal, state and institutional rules and regulations. The Federal Methodology is published annually and the ability to calculate an EFC is widely available. Accordingly, the student may provide his/her EFC, if known, in the Student Data to bypass the actual calculation, as desired.

In addition to the EFC, Affordability may also incorporate:

1. Student and parent supplied answers to questions asking the student's interest in student loans and work programs as well as the student's perceived ability to pay for and savings for college.

2. Ability to provide the amount of any outside scholarships to be considered in the overall financial aid award package for determining out-of-pocket expenses.

3. Ability to provide the amount of any planned additional Private or Parent Loan for Undergraduate Students (PLUS) loans to be considered in the overall financial aid award package for determining out-of-pocket expenses.

For Stage One, once the EFC and student dependency (according to the Federal Methodology) is determined, the student is able to choose from a set of financial aid profiles. These profiles may be presented as a low, medium and high EFC-based aid award examples. Aid awards are based on federal award methodology (i.e. Pell Grant tables ) and national averages (i.e. Campus Based Aid programs like Federal Work Study and Perkins Loan). In addition, the student has the ability to input as Student Data his/her scholarships awarded, and/or additional loan options to consider. This information creates an “Estimated Potential Aid” of Scholarship, Federal Grant, Federal Loan and Private Loan eligibilities, which is passed to the student Match Factor list. As a function of the matching of the Affordability Match Factors, a student is able to see which colleges have matched to him/her using the Match Algorithm as well as the projected 2 or 4-year costs and 2 or 4-year out of pocket expenses based on the type of college ( Out of Pocket expenses=4 year costs−4 years of potential aid as calculated above). This gives the student a full collegiate career analysis of the affordability of the school they are matching by taking financial aid into consideration. In this fashion, the system of the invention may present the aid package to the student on a school-to-school basis as one of the factors in matching to the school.

### Stage Two:

The second stage of affordability assessment includes customizing the student aid awards based on the exact student EFC. This differs from Stage One above in that in Stage One a student is presented with a choice of low, medium and high EFCs. Stage Two uses the student's supplied or calculated EFC and determines the exact aid awards as appropriate. This second stage expounds on Stage One as it further personalizes the affordability component by allowing a student a more accurate assessment of the aid that is available. In addition, Stage Two affordability is also a Match Factor in the Match Algorithm. In Stage One, the information is supplied and presented to the student but is not part of the matching calculation. In Stage Two, the out of pocket costs for the student will be used as a function of the algorithm's calculation in reference to the students desire to take affordability into account for the calculation. In this fashion, the system uses a student's personalized aid award package, combines it with the Match Algorithm, and combines the result with other college match factors to create a unique match to every school in the database.

### Stage Three:

Affordability in Stage Three expounds upon Stage Two calculations by further including state-by-state specific scholarship and grant programs and institutionally based scholarship programs as supplied by the school and by providing institutional-specific financial aid cost of attendance figures (which include, personal, miscellaneous and transportation costs in addition to tuition/fees and room/board charges) for a more accurate calculation of aid. Affordability calculation in Stage Three thus fully encompasses an institution-by-institution based analysis on a per student basis for the affordability calculation by the Match Algorithm.

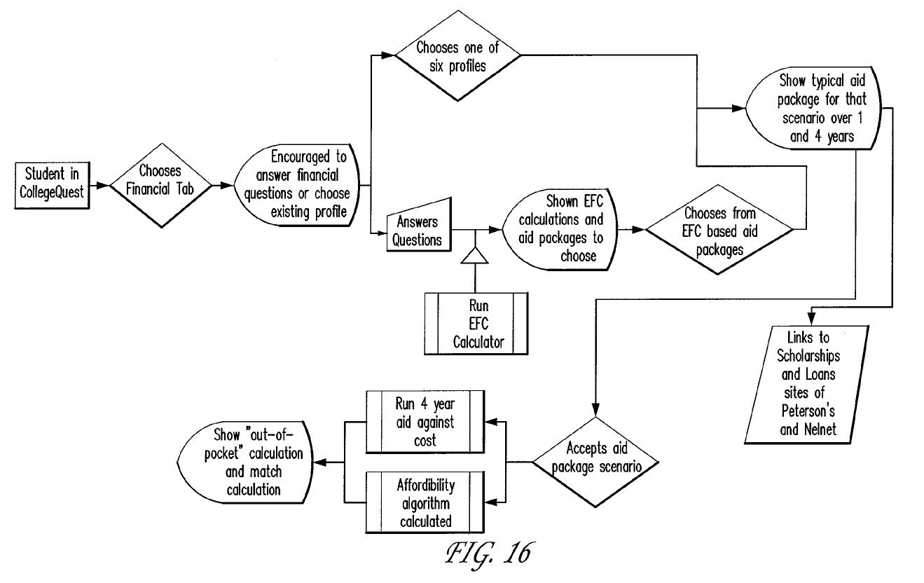

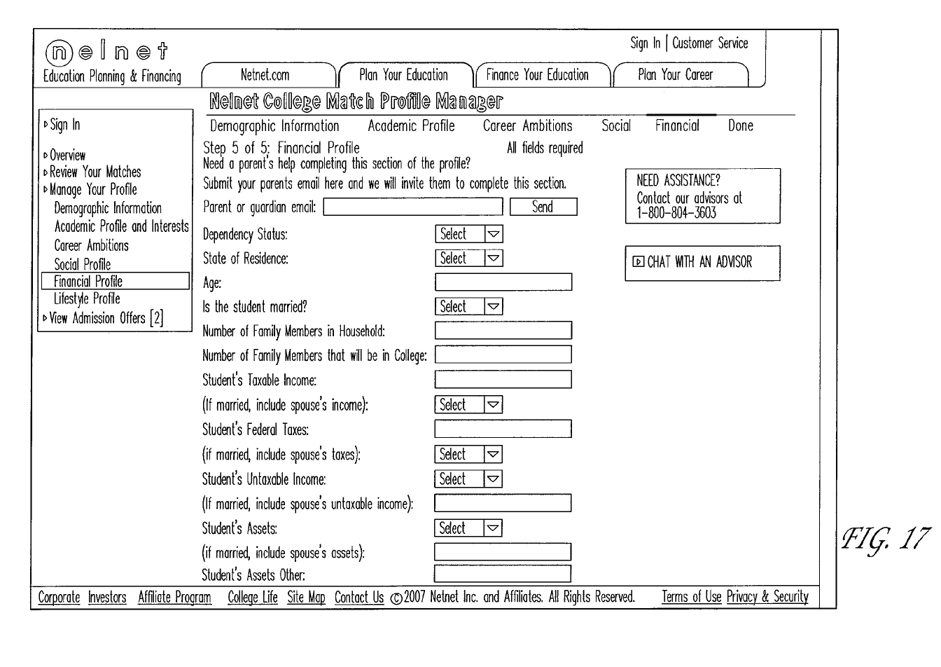

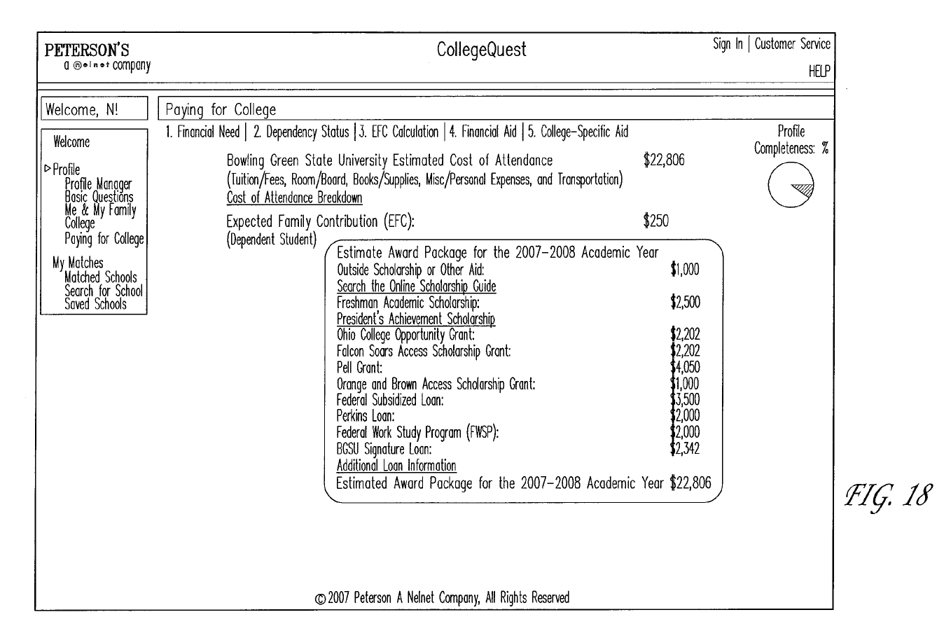

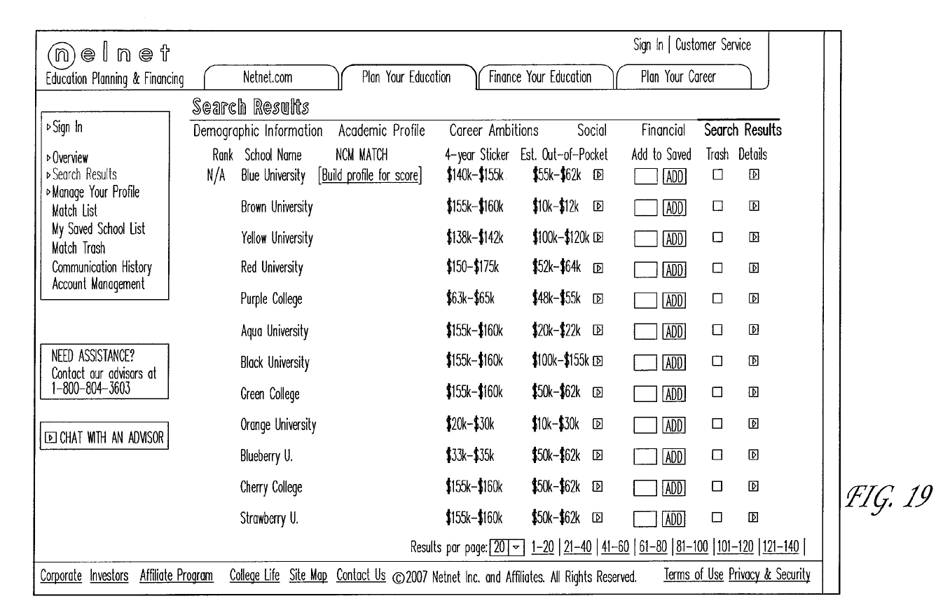

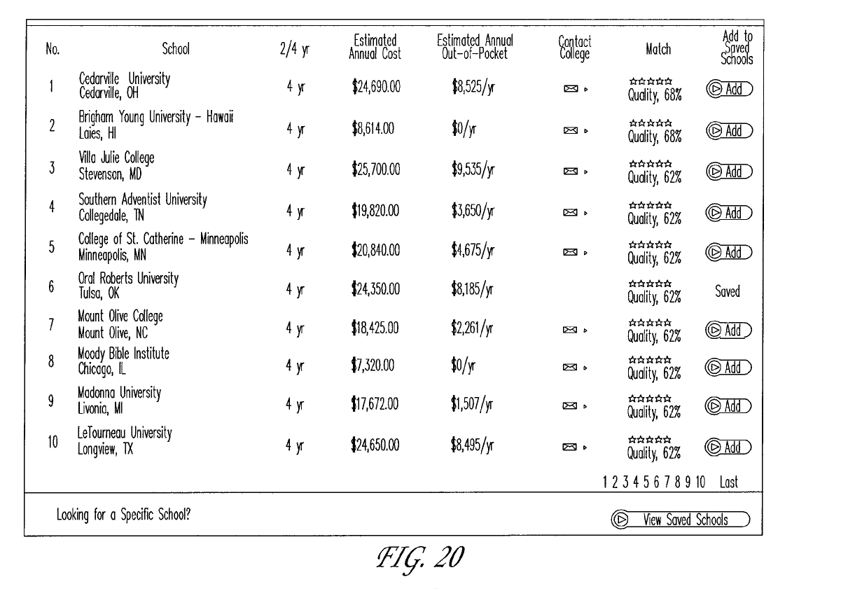

FIG. 16 illustrates a sample flow chart for calculating Affordability using the techniques herein described. As illustrated in FIG. 17, the student provides responses to financial questions to create a financial profile, and the responses are used to calculate the EFC for the student. The system compares average financial aid packages at various EFC levels to a student's calculated EFC. By combining a projected financial aid package with the school's cost data, the system can accurately project student-to-school out-of-pocket costs on a school-by-school basis. FIG. 18 illustrates a sample print out of the affordability assessment, or estimated award package, for a sample college for which such an Affordability calculation has been conducted in accordance with the invention. As noted above, this Affordability calculation may be used as a Match Factor in matching the student to a school and vice-versa. Use of the estimated out-of-pocket costs as a Match Factor is illustrated in FIG. 19, and a ranking of the Financial Match Factors for different schools is illustrated in FIG. 20.

The Affordability matching technique of the invention may also be used as a way for the system to generate and display a list of colleges that have the potential to maximize the return on investment for the student. The list is sourced from the analysis of the Match Algorithm as described above. As has been noted, the Match Algorithm matches across Academic, Social, and Financial inputs. If it is assumed that a student (Jane) has told the system about her academic and social preferences, it is safe to assume that a subset of good matches would be affordable matches defined as those matches that minimize out-of-pocket expenses and minimize education-related debt. In order to identify schools that minimize out-of-pocket expenses and debt, an analysis of the average financial aid packages received by families similar to Jane's is performed. The out-of pocket cost for Jane's target school then is a function of the school supplied costs minus the estimated aid package which has been calculated for her. It is noted that average financial aid packages awarded by colleges is known using federal and state award tables, national averages and maximum loan limits. Additional details, such as Jane's desired timeline (3, 10, 20, or some other number of years after graduation) to payoff education-related debt, could further inform high quality school matches across the financial dimension.

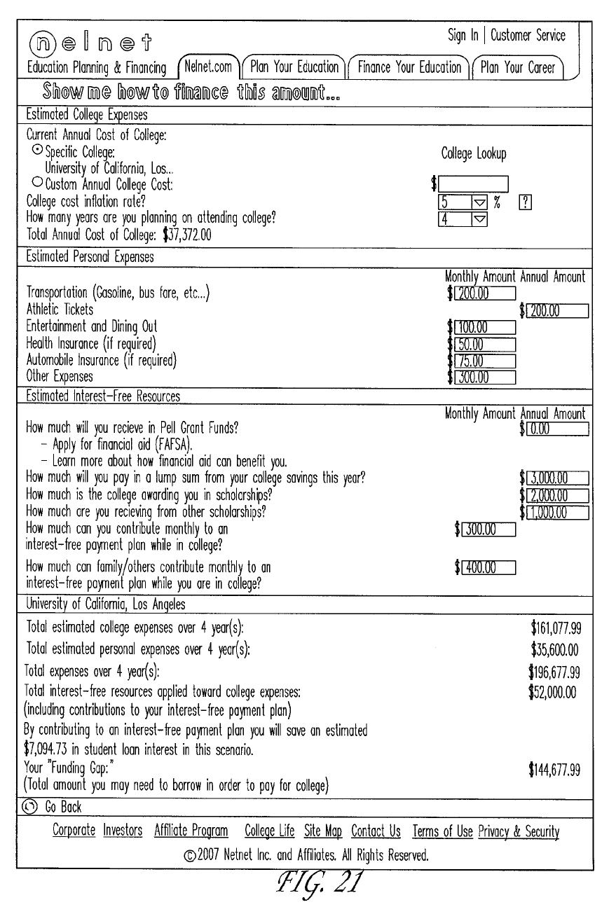

The Affordability matching may also provide a way for the colleges to generate a list of students that have a high likelihood to maximize tuition, fee, room, and donations. A college can match against the list by profile criteria to determine those students meeting certain financial characteristics. Conversely, as illustrated by the user interface in FIG. 21, the Affordability matching may also be used to assist a third party or a company associated with the web site operator to offer financial services that specifically target the student's needs.

Matching students to colleges across academic, social, and financial criteria alone can go a long way in identifying students that have a high likelihood to persist and graduate from a particular college. Retention research in the public domain identifies a handful of factors that correlate highly to retention. For example, the higher the level of degree earned by a student's mother, the higher the likelihood a student will persist and graduate. Beyond these nationally identified factors that predict college retention there may be school specific factors. For example, a school might find that students who live within 10 miles of campus persist and graduate or donate at higher rates than other students. By supplying that data as part of the School Data, such data may be factored into the Match Algorithm to enable schools to find the students who have the greatest likelihood to persist and graduate from or donate to a specific school.

Thus, colleges may query the Student Data for students who match a desired profile. A profile might be, for example, students who live within 100 miles of campus, who love math, who have a low household income, who are Catholic, and who are seeking a campus with more than 2,000 students. Beyond simply selecting these students from the Student Data, the Match Algorithm will filter out those students it deems are not a good match for the inquiring school. An example screen shot of a prospect finder for this purpose is illustrated in FIG. 14.

The Affordability Match also provides a way for the student to see—on a school by school basis—a precise estimate of expected out-of-pocket cost. Thus, based on a family's household financial information, financial aid information from the colleges may be leveraged to produce an estimated sticker price which varies from the list tuition price. As noted above, this may be done by receiving asset information from the student's family and analyzing the average financial aid packages received by families similar to a family seeking this analysis. The estimated financial aid package that a specific family might receive can then be subtracted from the list price of tuition.

L. Graphical User Interface

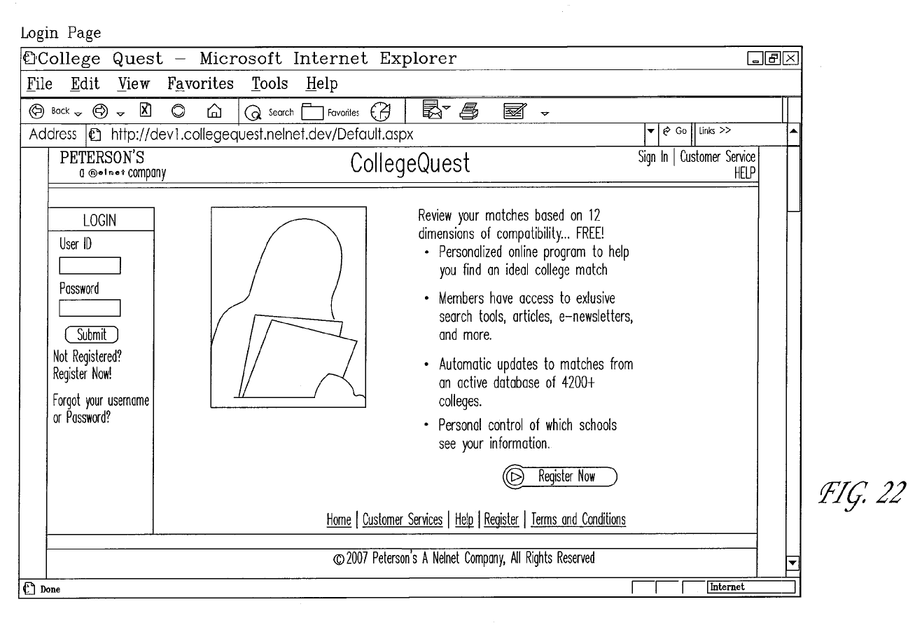

FIGS. 22-40 illustrate examples of a graphical user interface for interacting with the student/college matching system of the invention.

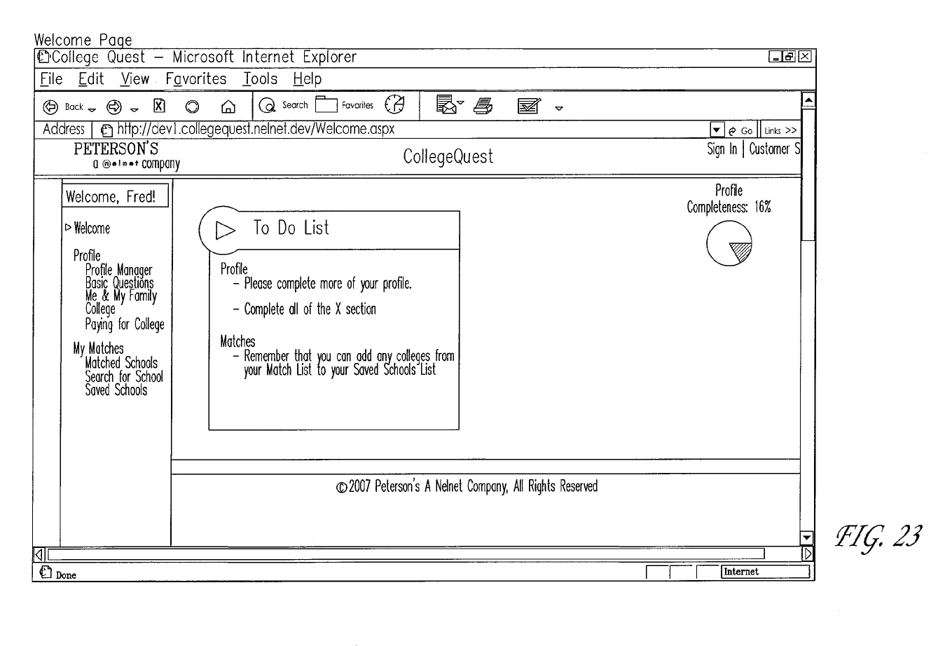

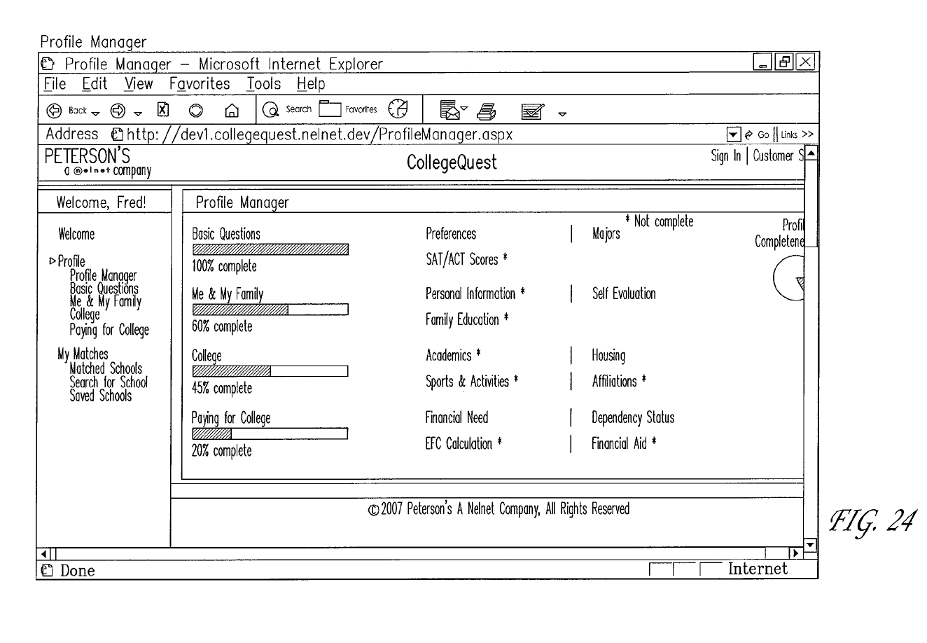

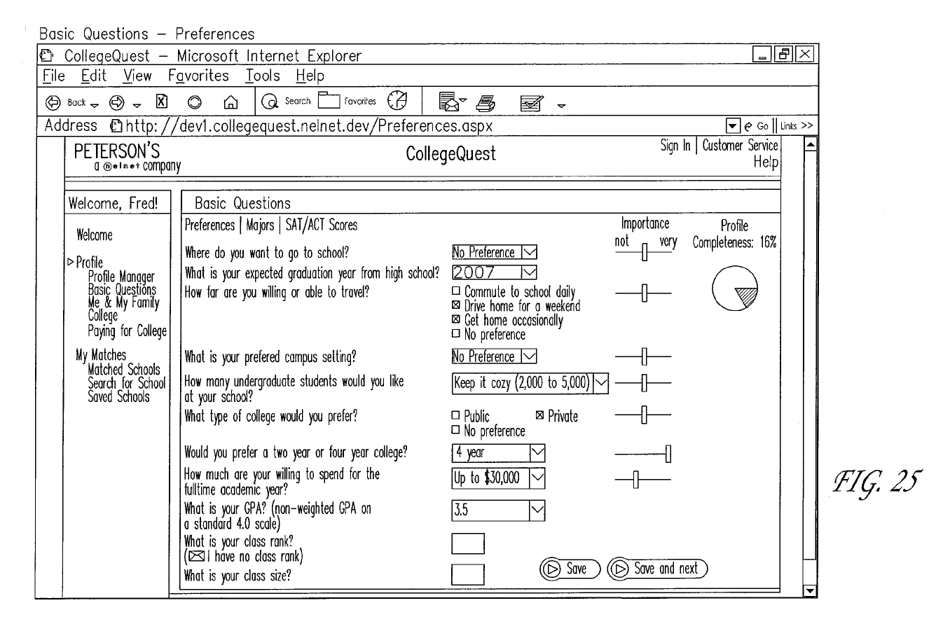

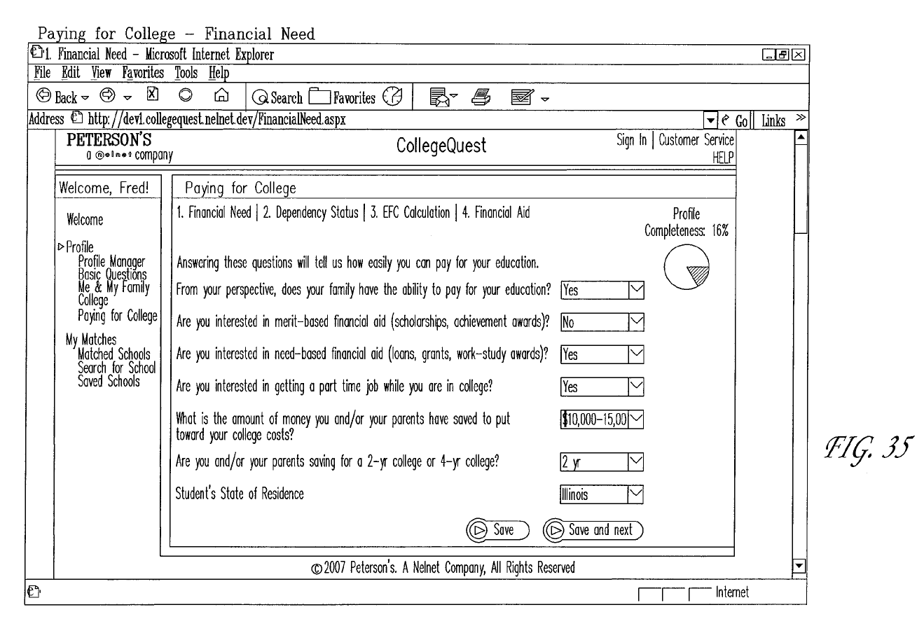

FIG. 22 illustrates a login page for the user to login to the matching system of the invention. As illustrated, the user is solicited to provide a user ID and password to enable system access. Once the proper user ID and password is provided, the student is presented with a welcome page, such as that illustrated in FIG. 23. In FIG. 24, the user has further selected the option of updating his/her Student Profile. A profile manager guides the student through a series of questions used to generate the Student Profile. Sample questions for completing the Student Profile are illustrated by way of example in FIGS. 25-40. As illustrated in FIGS. 35-40, such questions may also elicit financial information for development of the aforementioned Affordability Match Factor. Similar interfaces may be provided to enable school administrators to enter the profile data for the school, or else the School Data may be directly imported from survey responses and the like.

M. Software Implementation

Although not required, the Match Algorithm pipeline can be implemented in whole or in part via an operating system (OS), for use by a developer of services for a device or object, and/or included within application software that operates in connection with any virtualized OS used for implementation of the invention. Software may be described in the general context of computer-executable instructions, such as program modules, being executed by one or more computers, such as client workstations, servers or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with a variety of computer system configurations and protocols. Other well known computing systems, environments, and/or configurations that may be suitable for use with the invention include, but are not limited to, personal computers (PCs), server computers, hand-held or laptop devices, multi-processor systems, microprocessor-based systems, programmable consumer electronics, network PCs, appliances, minicomputers, mainframe computers and the like. The invention also may be practiced in distributed computing environments where tasks are performed by remote processing devices that are linked through a communications network/bus or other data transmission medium. In a distributed computing environment, program modules may be located in both local and remote computer storage media including memory storage devices, and client nodes may in turn behave as server nodes.

A server or other computer implementing the Match Algorithm typically includes a variety of computer readable media. Computer readable media can be any available media that can be accessed by a computer and includes both volatile and nonvolatile media, removable and non-removable media. By way of example, and not limitation, computer readable media may comprise a variety of computer storage media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other computer readable medium that may be used to store the desired information and which can be accessed by a computer. Combinations of any of the above should also be included within the scope of computer readable media. It is specifically contemplated that the methodology described herein is implemented in software in computer readable media that may be read by a computer processor for reconfiguration of the general purpose computer into a device or system for implementation of the system described herein.

As mentioned, the various techniques described herein may be implemented in connection with hardware or software or, where appropriate, with a combination of both. Thus, the methods and apparatus of the invention, or certain aspects or portions thereof, may take the form of program code (i.e., instructions) embodied in tangible media, such as CD-ROMs, DVDs, flash drives, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the techniques of the invention, e.g., through the use of a data processing API, reusable controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

While the invention has been described in connection with the preferred embodiments of the various figures, it is to be understood that other similar embodiments may be used or modifications and additions may be made to the described embodiment for performing the same function of the invention without deviating therefrom. Therefore, the invention should not be limited to any single embodiment, but rather should be construed in breadth and scope in accordance with the appended claims. For example, while the exemplary embodiment is described in the context of matching students and colleges, the system described herein may also be used to match students to all types of schools or learning institutions such as law schools, medical schools, business schools, graduate programs, universities, trade schools, boarding schools, and the like. Further, the algorithms and processes are intended as specific implementations only and are not intended to delimit the scope of the invention, which should instead be understood with reference to the following claims.

What is claimed:

1. A method of matching a student to a learning institution, comprising:
accepting information from a student relating to the student's characteristics and interests in a learning institution and creating a student profile for the student;
accepting information relating to the characteristics of a plurality of learning institutions and creating an institution profile for each respective learning institution;
matching the student profile with the institution profiles to identify those learning institutions of the plurality of learning institutions that best match the student's characteristics and interests; and
providing a listing of the best matched learning institutions to the student.

2. A method as in claim 1, further comprising accepting an indication from the student indicating how important certain characteristics of the learning institution is to the student.

3. A method as in claim 1, further comprising determining the reliability of the data representing the student's characteristics and/or the reliability of the data representing the characteristics of respective learning institutions.

4. A method as in claim 3, further comprising ranking the listing based on the reliability of the data used in the matching.

5. A method as in claim 1, wherein the matching matches the student profile to institution profiles using a moderation algorithm whereby a learning institution with characteristics similar to each respective characteristic of the student profile is preferred over a learning institution that closely matches certain characteristics of the student profile but does not closely match other characteristics of the student profile.

6. A method as in claim 1, wherein the matching provides overall matches between the student profile and the respective institution profiles and one or more sub-matches between certain characteristics of the student and corresponding characteristics of the respective learning institutions.

7. A method as in claim 1, wherein the student profile includes financial information regarding the student's modality of payment for an education.

8. A method as in claim 7, further comprising presenting education financing options to the student based on a match between the student's financial information and cost information for the student for attending the school.

9. A method as in claim 1, wherein the student profile includes persistence information regarding the likelihood that the student will persist as a student and graduate.

10. A method as in claim 1, wherein the matching includes matching the student to a school based on factors relating to the fitness of the student to attend the school and the feasibility that the student may be admitted to the school over other candidates.

11. A method of identifying student candidates for attendance at a learning institution, comprising:
accepting information from a plurality of students relating to the students' characteristics and interests in a learning institution whereby the information is indicative of whether the student is likely to move from a point of interest to an actually enrolled student and persist to graduation, and creating student profiles for the students;
accepting information relating to the characteristics of the learning institution and creating an institution profile for the learning institution;
matching the institution profile with the student profiles to identify those students of the plurality of students that best match the institutions characteristics and interests; and
providing a listing of the best matched students to the learning institution.

12. A method as in claim 11, further comprising enabling the learning institution to send a solicitation to a student and for the student to release his or her contact information and/or student profile to the learning institution.

13. A method as in claim 11, further comprising charging the learning institution for access to said listing, the cost of the access being proportionate to the quality and/or the quantity of the matches in the listing.

14. A system for matching a student to a learning institution, comprising:
a student database including a student profile including information relating to the student's characteristics and interests in a learning institution;
a learning institution database including an institution profile for each respective learning institution, each institution profile including information relating to the characteristics of the respective learning institution;
a matching algorithm that matches the student profile with the institution profiles to identify those learning institutions of the plurality of learning institutions that best match the student's characteristics and interests; and
a user interface that provides a listing of the best matched learning institutions to the student.

15. A system as in claim 14, wherein the matching algorithm includes a plurality of factor algorithms that match each characteristic of the student to corresponding characteristics of the learning institution to create match factors.

16. A system as in claim 15, wherein the matching algorithm further includes a score algorithm that calculates match scores between the student and each learning institution using weighted combinations of said match factors.

17. A system as in claim 16, wherein the matching algorithm further includes a rating algorithm that rates the match between the student and each learning institution using said match scores.

18. A system as in claim 17, wherein the rating algorithm further determines a quality score for the match based on the reliability of the data used in the student profile and each institution profile and ranks the listing based on the quality score.

19. A system as in claim 14, wherein the matching algorithm includes a moderation algorithm whereby a learning institution with characteristics similar to each respective characteristic of the student profile is preferred over a learning institution that closely matches certain characteristics of the student profile but does not come close to matching other characteristics of the student profile.

20. A system as in claim 14, wherein the matching algorithm matches the affordability of the learning institution by the student based on financial information regarding the student's modality of payment for an education.

21. A system for identifying student candidates for attendance at a learning institution, comprising:
a student database including a plurality of student profiles including information relating to the student's characteristics and interests in a learning institution whereby the information is indicative of whether the student is likely to move from a point of interest to an actually enrolled student and persist to graduation;
a learning institution database including an institution profile for the learning institution including information relating to the characteristics of the respective learning institution;
a matching algorithm that matches the respective student profiles with the institution profile to identify those students of the plurality of students that best match the institution's characteristics and interests; and
a user interface that provides a listing of the best matched students to the learning institution.

22. A system as in claim 21, further comprising means for enabling the learning institution to send a solicitation to a student and for the student to release his or her contact information and/or student profile to the learning institution.

23. A computer readable medium containing instructions that when processed by a processor cause the performance of the steps of:
matching at least one student profile including the at least one student's characteristics and interests in a learning institution with at least one institution profile including the characteristics of said at least one learning institution to identify a degree of matching between the respective students and learning institutions; and
providing a listing of the degree of matching between said at least one learning institution to said at least one student.

24. A computer readable medium as in claim 23, further comprising instructions that enable a student to indicate how important certain characteristics of the learning institution are to the student and to weight respective characteristics for matching based on the indicated importance.

25. A computer readable medium as in claim 23, further comprising instructions that weight characteristics based on the reliability of the source of the data representing the student's characteristics and/or the reliability of the data representing the characteristics of respective learning institutions.
